(19) United States
(12) Patent Application Publication
(10) Pub. No.: US 2014/0146007 A1
(43) Pub. Date: May 29, 2014

(54) TOUCH-SENSING DISPLAY DEVICE AND DRIVING METHOD THEREOF

(71) Applicant: SAMSUNG ELECTRONICS CO., LTD., SUWON-SI (KR)

(72) Inventors: CHANG-JU LEE, SUWON-SI (KR); JONG-KON BAE, SEOUL (KR); WON-SIK KANG, SEOUL (KR); YANG-HYO KIM, SUWON-SI (KR); JAE-HYUCK WOO, OSAN-SI (KR)

(73) Assignee: SAMSUNG ELECTRONICS CO., LTD., SUWON-SI (KR)

(21) Appl. No.: 14/029,395

(22) Filed: Sep. 17, 2013

(30) Foreign Application Priority Data
Nov. 26, 2012 (KR) 10-2012-0134683

(51) Int. Cl. G06F 3/044; G06T 3/00

(52) U.S. Cl. CPC G06F 3/044; G06T 3/0006
USPC 345/174

(57) ABSTRACT

A display device includes a touch sensor controller configured to identify a gesture. A display driver integrated circuit (IC) is configured to flip, scroll, or shrink an image based on the results of identification, which are received from the touch sensor controller. Accordingly, a user may more easily touch one or more touch targets displayed on the display device with just one hand.

### CROSS-REFERENCE TO RELATED APPLICATION

This application claims priority under 35 U.S.C. §119 to Korean Patent Application No. 10-2012-0134683 filed on Nov. 26, 2012, the disclosure of which is hereby incorporated by reference in its entirety.

### TECHNICAL FIELD

Embodiments of the inventive concept relate to display devices, and more particularly, to display devices including a touch-sensing panel and a display module, and a driving method thereof.

### DISCUSSION OF RELATED ART

Screens of conventional smart phones are about 4 inches long, as measured on a diagonal distance between two opposite screen corners. Conventional smart phones such as these may be easily utilized with a single hand that both grips the device and touches the touch-screen targets.

Recently, the screens of some modern smart phones have become substantially larger than 4 inches. For example, screens are 5.3 inches long in the case of the Galaxy Note™ manufactured by Samsung, and are 5.5 inches long in the case of the Galaxy Note 2™ manufactured by Samsung. As screens of smart phones exceed 4 or 5 inches long, many users will have difficulties handling these smart phones with just one hand. For example, a user will have difficulties inputting the number ‘3’ when he or she inputs telephone numbers to a smart phone with his/her left hand, or will have difficulties inputting the number ‘1’ when he or she inputs telephone numbers to the smart phone with his/her right hand.

Furthermore, when a large-screen smart phone is used forcefully with one hand, the smart phone may be damaged.

### SUMMARY

Embodiments of the inventive concept provide a display device that can be operated with just one hand, and a driving method thereof.

The technical objectives of the inventive concept are not limited to the above disclosure; other objectives may become apparent to those of ordinary skill in the art based on the following descriptions.

In accordance with an aspect of the inventive concept, a display device which displays an image includes a touch sensor controller configured to determine a gesture, and a display driver integrated circuit (IC) configured to flip or scroll an image based on the results of determining the gesture, which are received from the touch sensor controller.

In an embodiment, the gesture may include a clockwise motion or a counterclockwise motion.

In an embodiment, the flipping of the image may include inverting the image to be flipped from top to bottom or from left to right.

In an embodiment, the scrolling of the image may include shifting all regions or a partial region of the image from top to bottom or from left to right.

In an embodiment, the display device may further include an image processor configured to control the display driver IC.

In an embodiment, the image processor may include the touch sensor controller.

In an embodiment, the image processor may be embodied as a functional block of an application processor, and the application processor may include the touch sensor controller.

In an embodiment, the touch sensor controller may be embodied as a functional block of the display driver IC.

In an embodiment, the display driver IC may include a set value for flipping or scrolling the image.

In accordance with an aspect of the inventive concept, a method of driving a display device that displays an image includes determining a gesture, and flipping or scrolling the image based on the results of determining the gesture.

In an embodiment, the method may further include setting a partial region of the image.

In an embodiment, the setting of the partial region may include touching a first point on the image, and touching a second point with an X-axis coordinate and a Y-axis coordinate that are not the same as those of the first point. A range of an X-axis of the partial region may be set using the X-axis coordinates of the first and second points, and a range of a Y-axis of the partial region may be set using the Y-axis coordinates of the first and second points.

In an embodiment, the setting of the partial region may include touching a first point on the image, touching a second point with a Y-axis coordinate that is the same as that of the first point to set a range of an X-axis of the partial region, and touching a third point with an X-axis coordinate that is the same as that of the second point to set a range of a Y-axis of the partial region.

In an embodiment, the flipping of the image may include inverting all regions or the partial region of the image from top to bottom or from left to right.

In an embodiment, the scrolling of the image may include shifting all regions or the partial region of the image from top to bottom or from left to right.

A display device which displays an image includes a touch sensor controller configured to identify a gesture made by a user on the display device and send an indication of the identification of the gesture. A display driver integrated circuit (IC) is configured to receive the indication of the identification of the gesture from the touch sensor controller and to flip, scroll, or shrink an image displayed on the display device in response to the receipt of the indication of the identification of the gesture. The flipping, scrolling, or shrinking brings one or more touch targets displayed on the display device closer to a corner of the display device that is more easily accessible to the user.

A method of driving a display device that displays an image includes identifying a gesture made by a user on the display device. The image is flipped, scrolled or shrunk when the gesture is identified. The flipping, scrolling, or shrinking brings one or more touch targets of the image closer to a corner of the display device that is more easily accessible to the user.

A computer device includes a touch screen configured to display an image and sense user contact with the touch screen. A processing device is configured to interpret the sensed user contact, identify a gesture made by a user therefrom, and generate an identification signal when the gesture is identified. A display driver integrated circuit (IC) is configured to receive the identification signal and alter a display of the image in response to the received identification signal. The altering of the display of the image brings one or more touch targets displayed on the display device closer to a corner of the display device that is more easily accessible to the user.

### BRIEF DESCRIPTION OF THE DRAWINGS

The foregoing and other features and aspects of the inventive concepts will be apparent from the description of embodiments of the inventive concepts, as illustrated in the accompanying drawings in which like reference characters may refer to the same parts throughout the different views. The drawings are not necessarily to scale. In the

### DRAWINGS

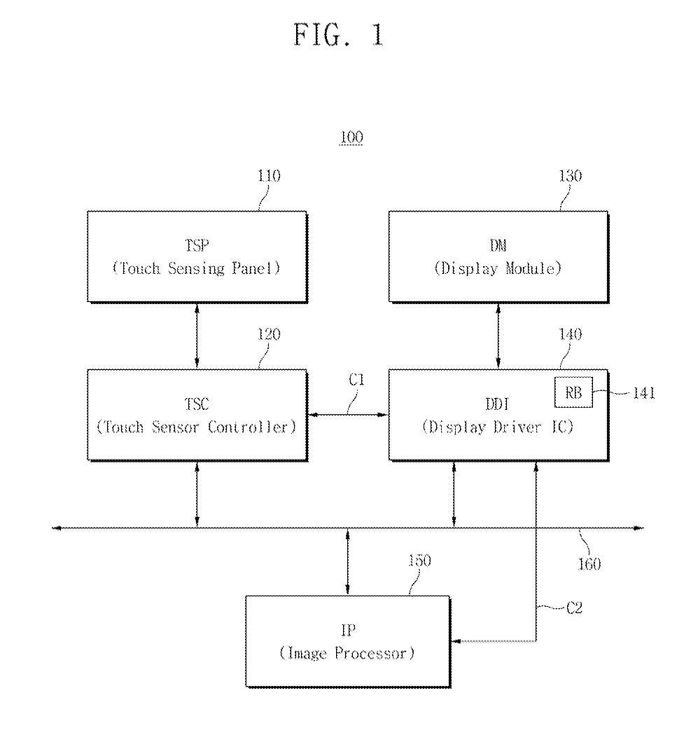

FIG. 1 is a block diagram of a display device in accordance with an exemplary embodiment of the inventive concept;

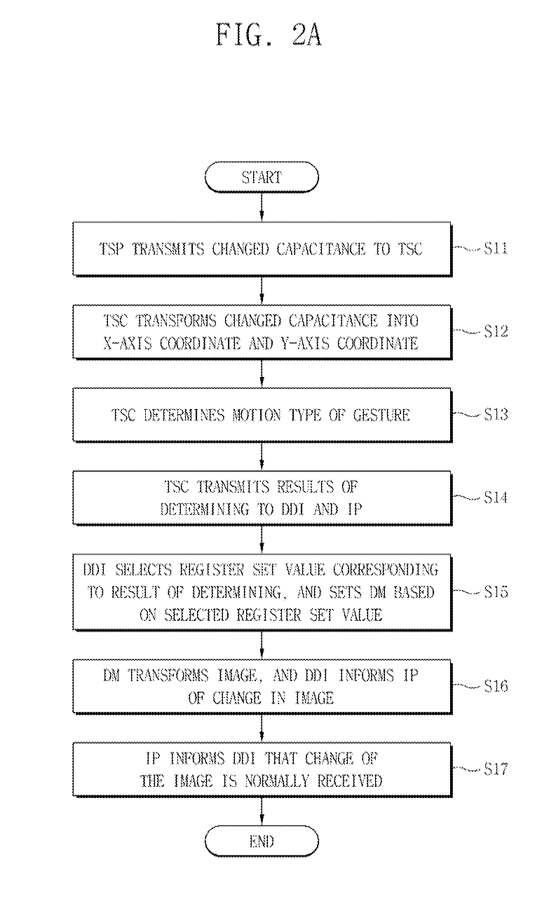

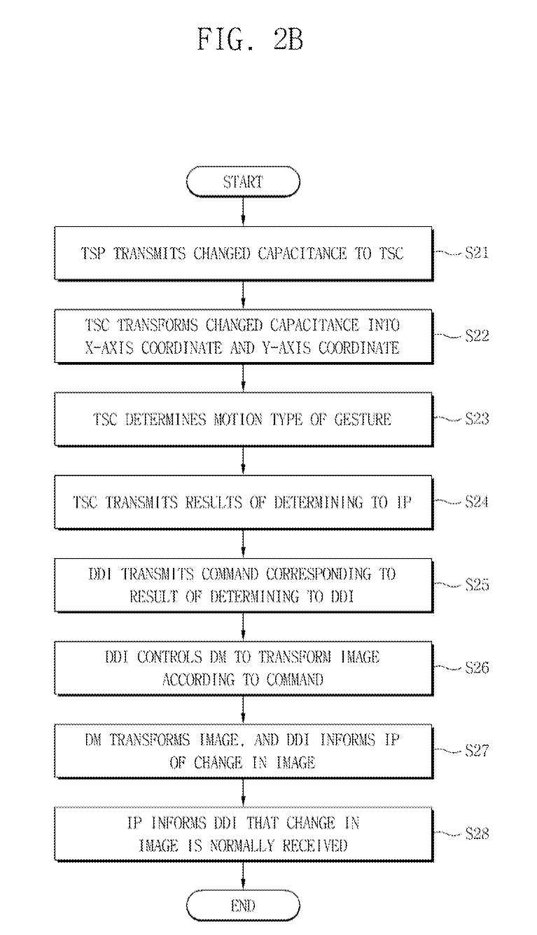

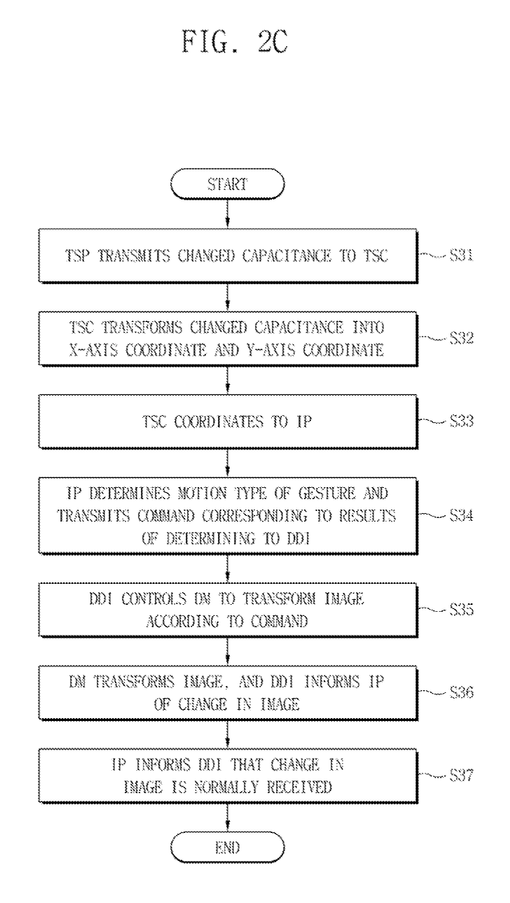

FIGS. 2A to 2C are flowcharts illustrating methods of driving the display device of FIG. 1 in accordance with exemplary embodiments of the inventive concept;

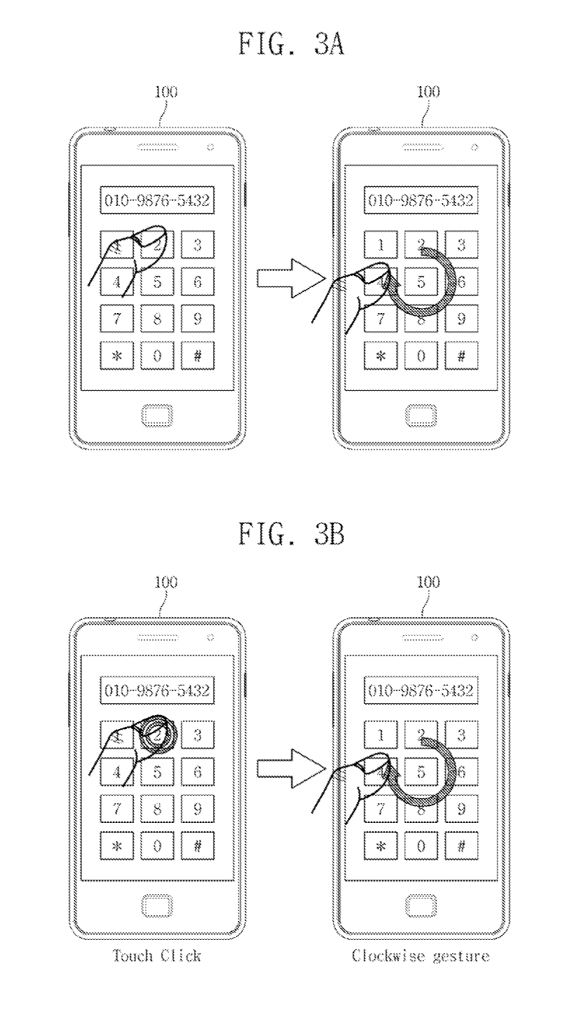

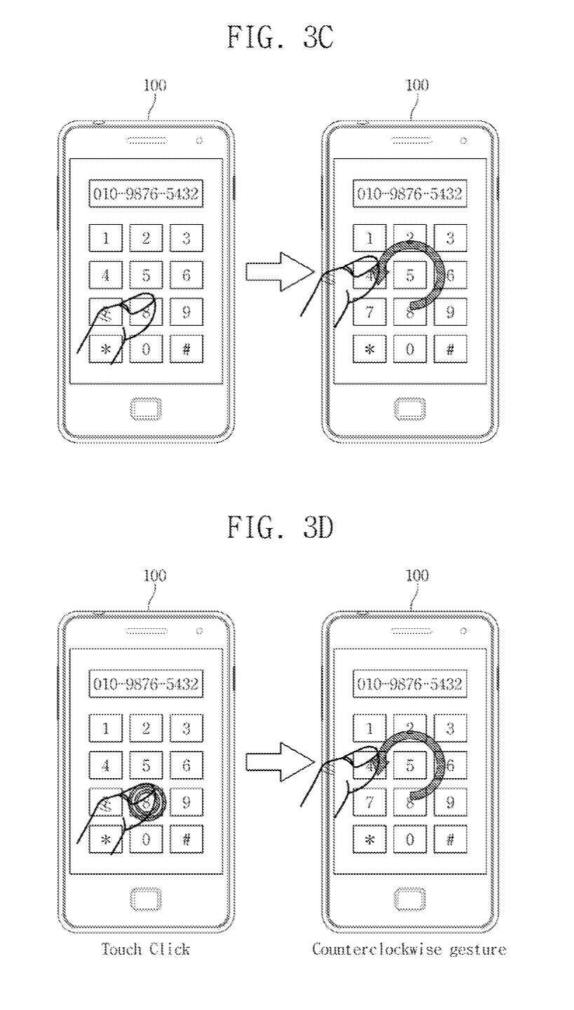

FIGS. 3A to 3D illustrate gestures input to a touch-sensing panel of FIG. 1 in accordance with exemplary embodiments of the inventive concept;

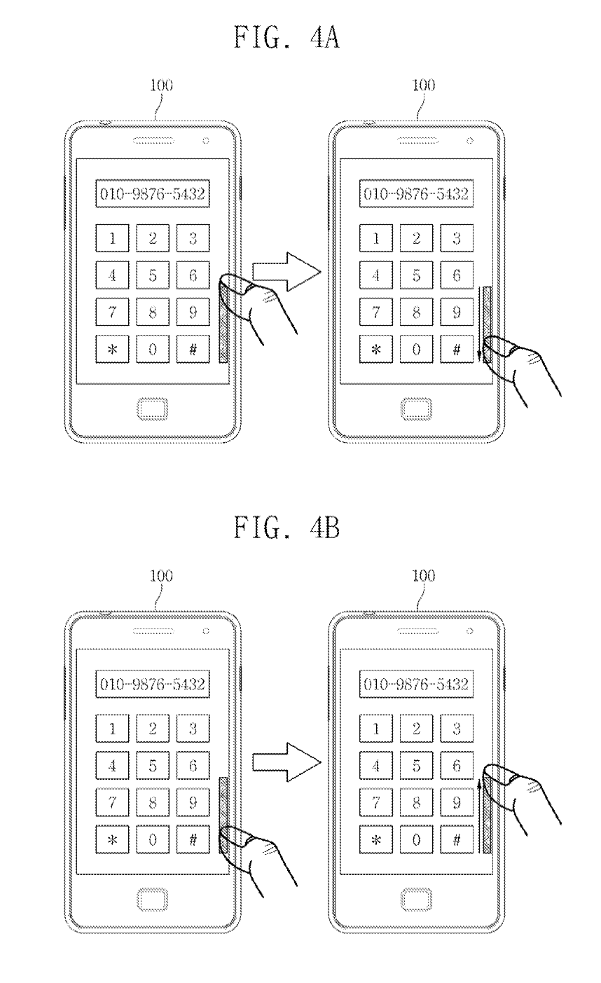

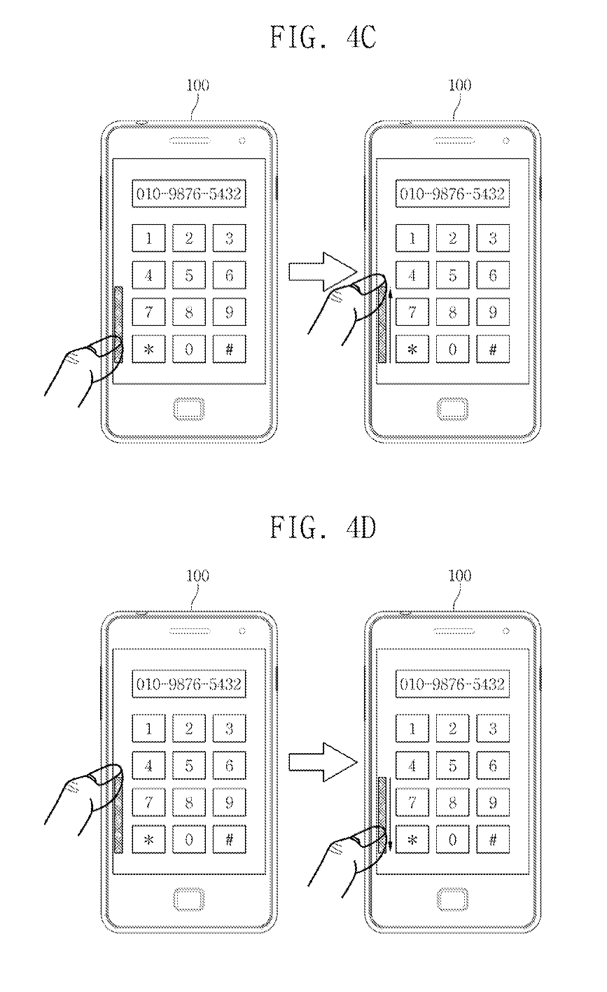

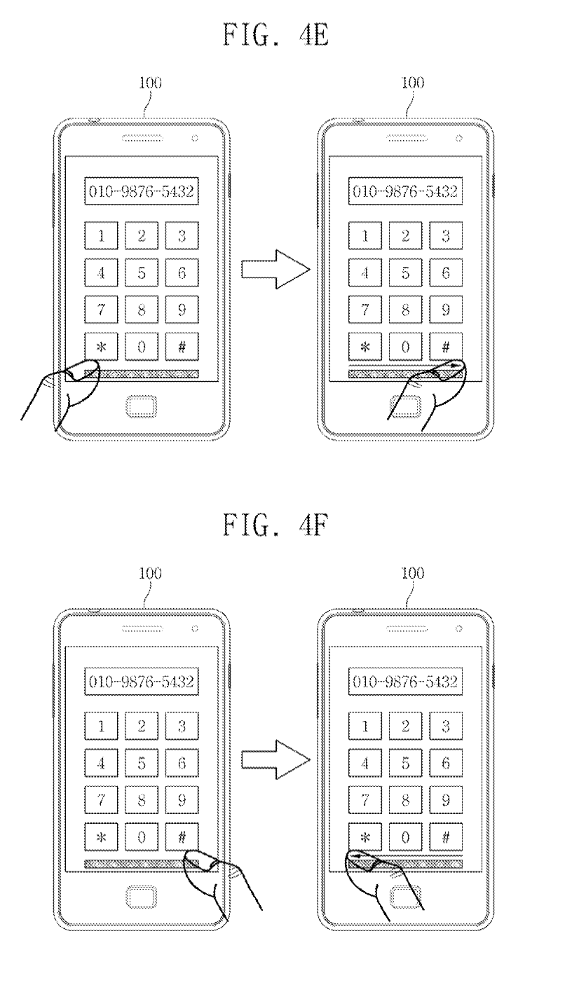

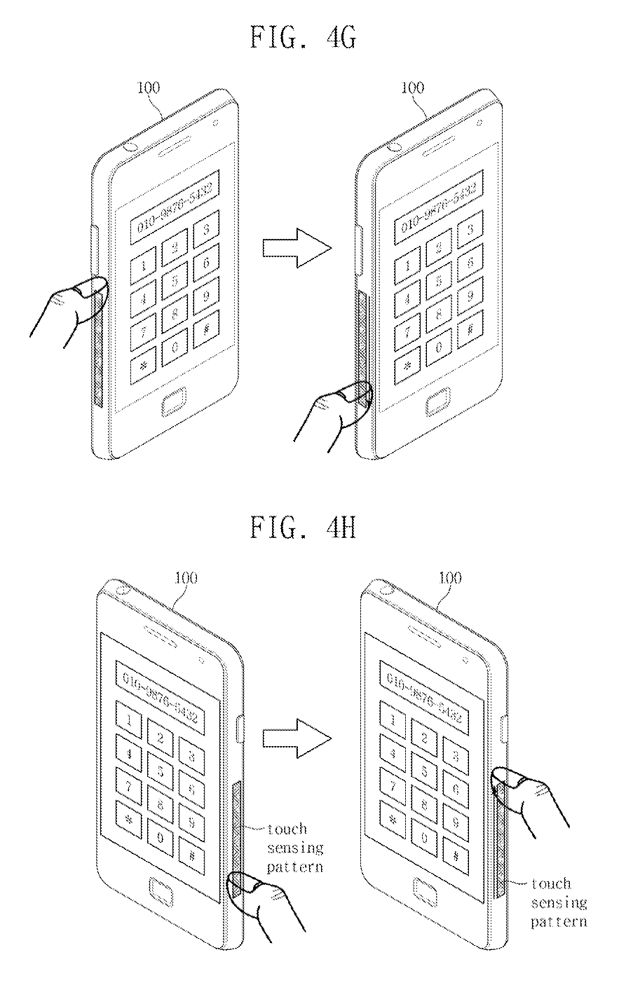

FIGS. 4A to 4J illustrate gestures input to the touch-sensing panel of FIG. 1 in accordance with exemplary embodiments of the inventive concept;

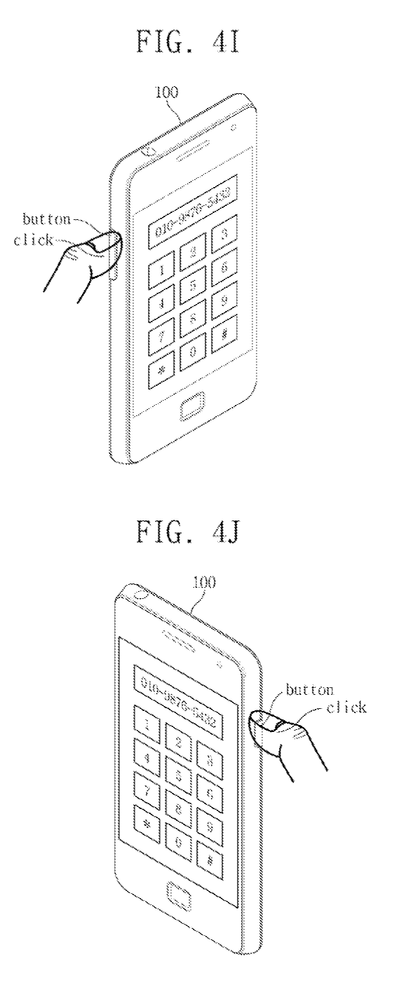

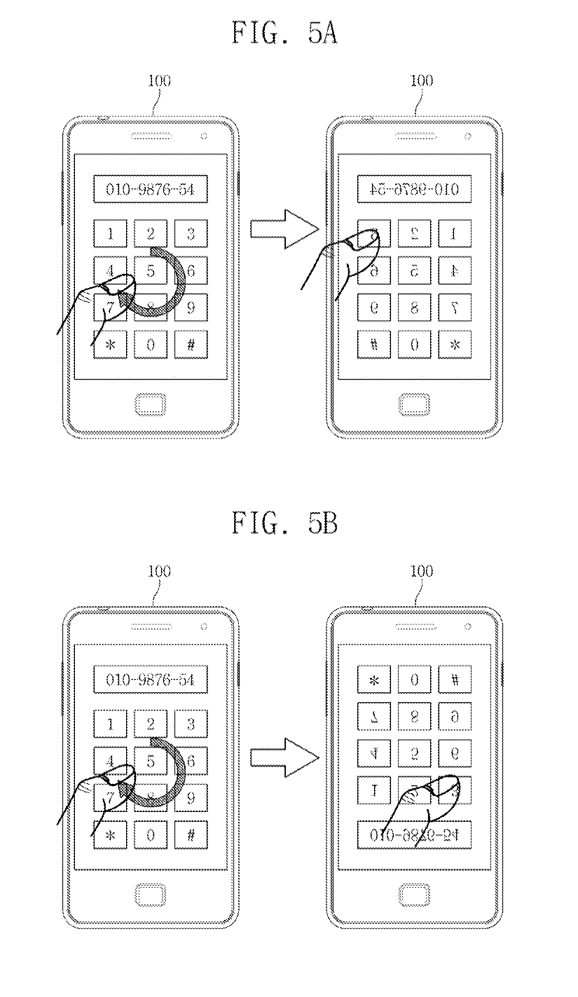

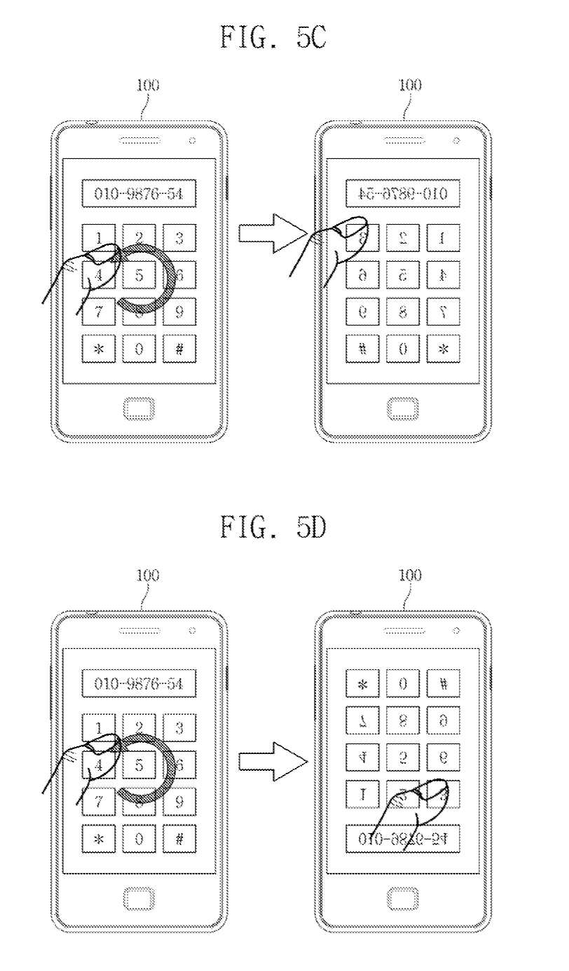

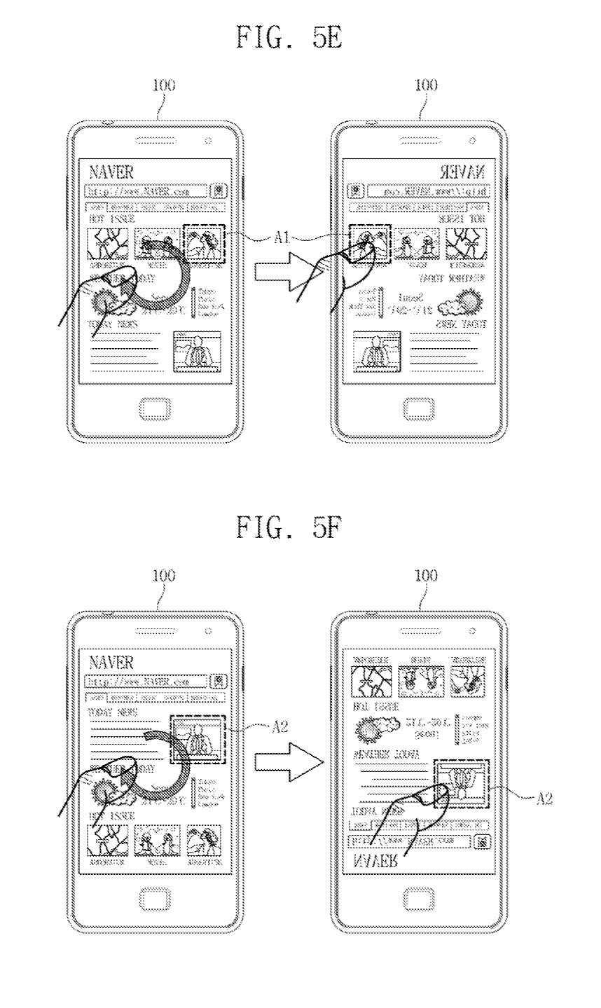

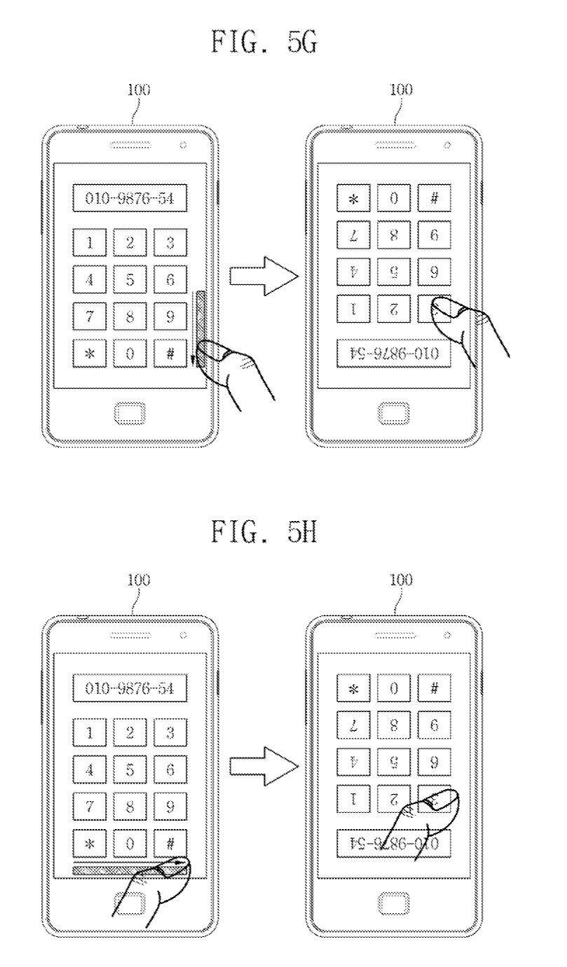

FIGS. 5A to 5J illustrate flipping an image displayed on the display device of FIG. 1 in accordance with exemplary embodiments of the inventive concept;

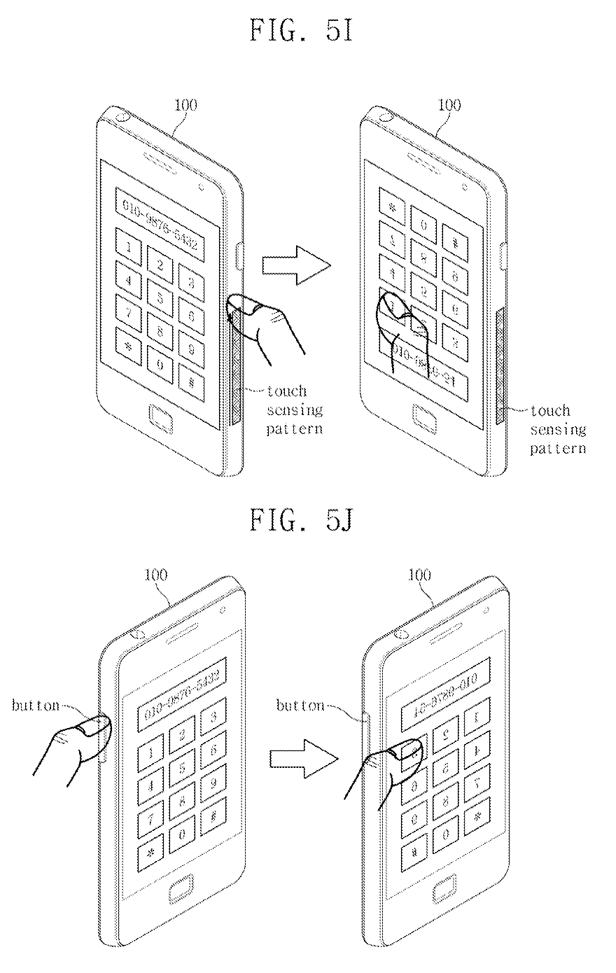

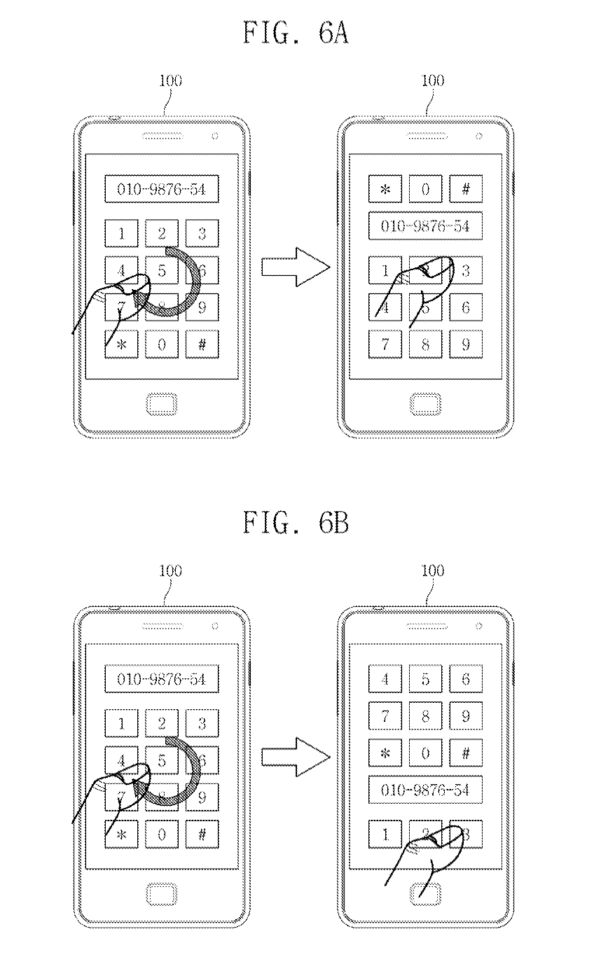

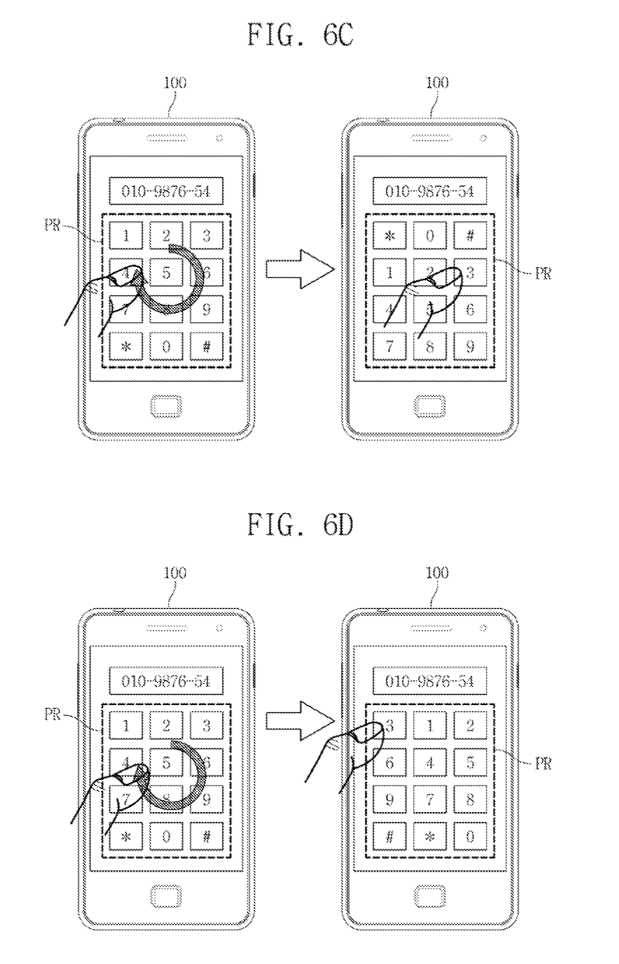

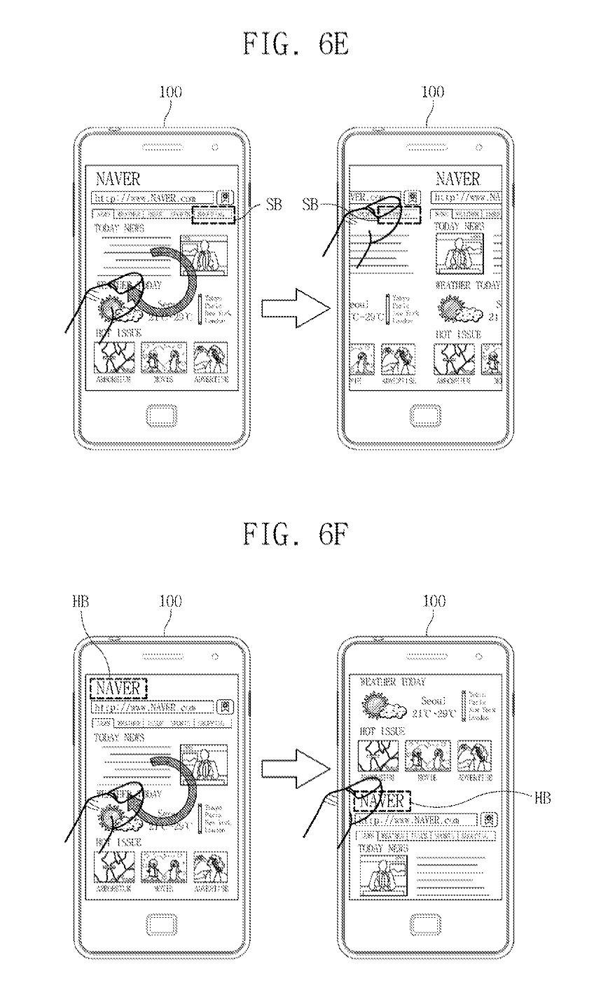

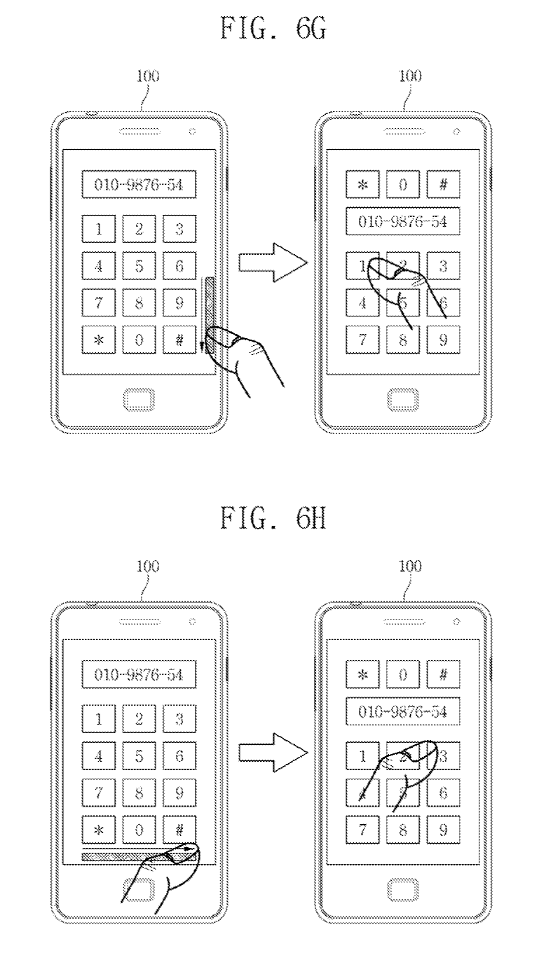

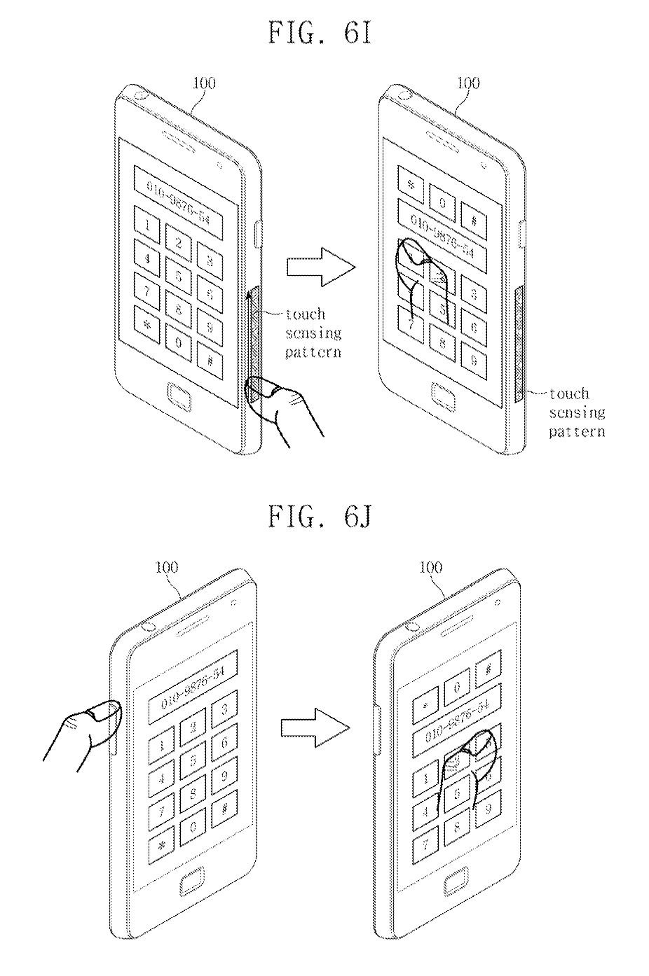

FIGS. 6A to 6J illustrate scrolling an image displayed on the display device of FIG. 1 in accordance with exemplary embodiments of the inventive concept;

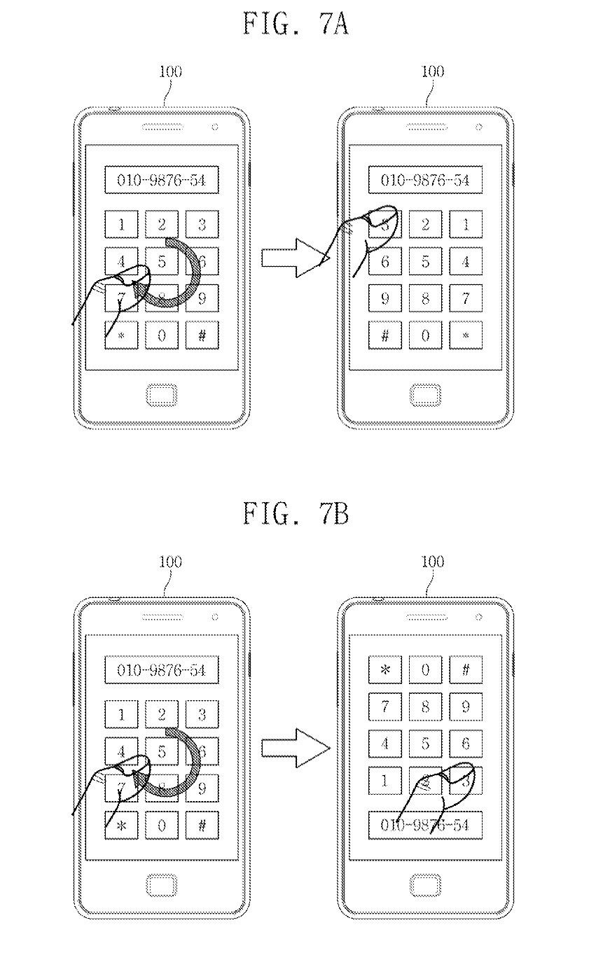

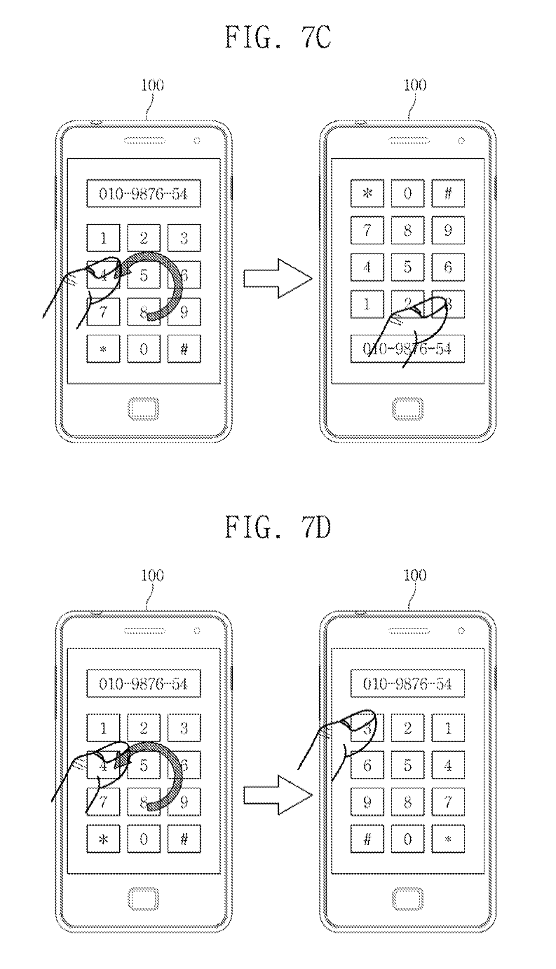

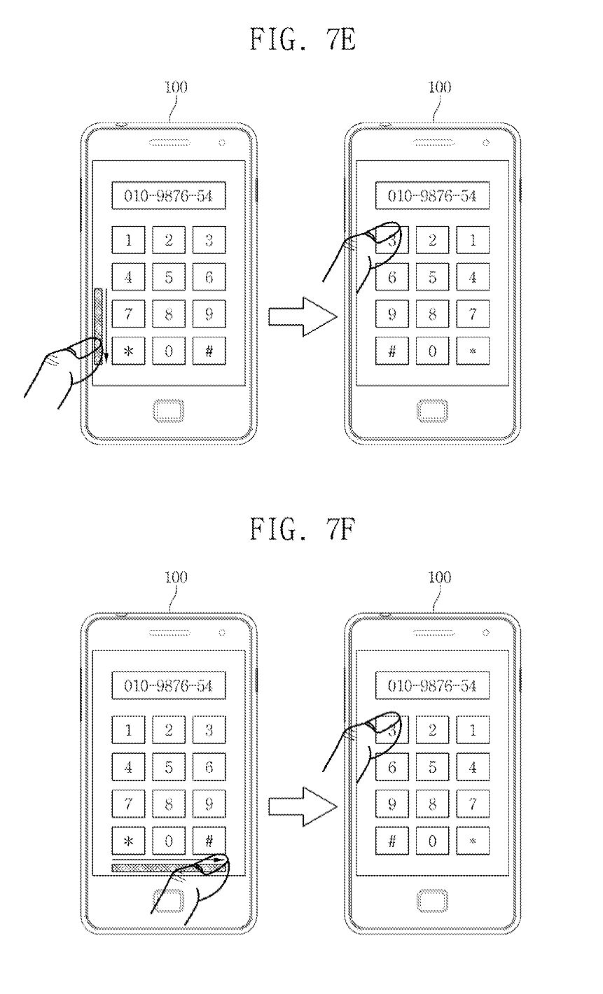

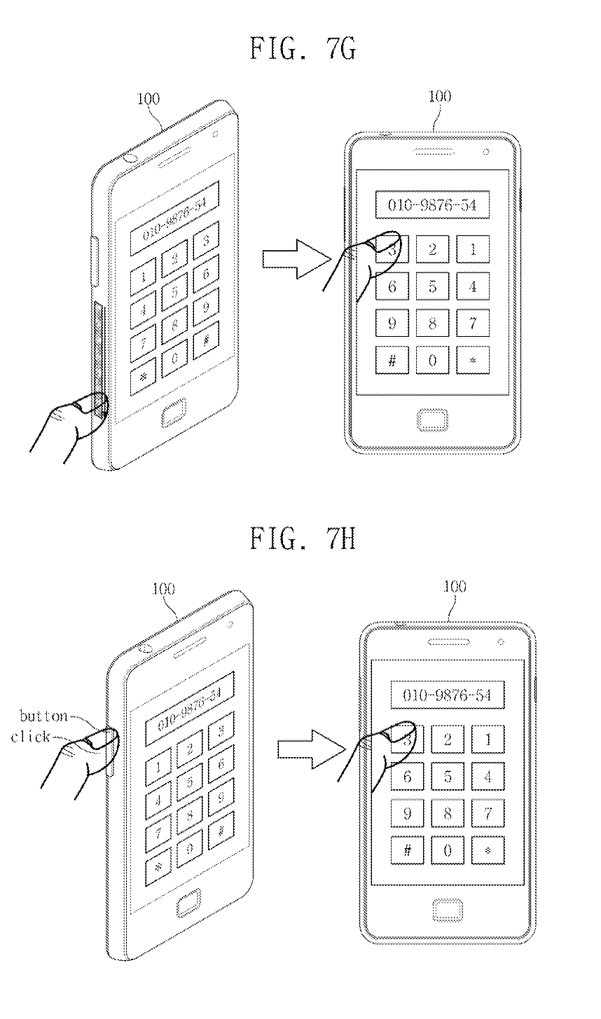

FIGS. 7A to 7H illustrate flipping an image displayed on the display device of FIG. 1 using an image processor in accordance with exemplary embodiments of the inventive concept;

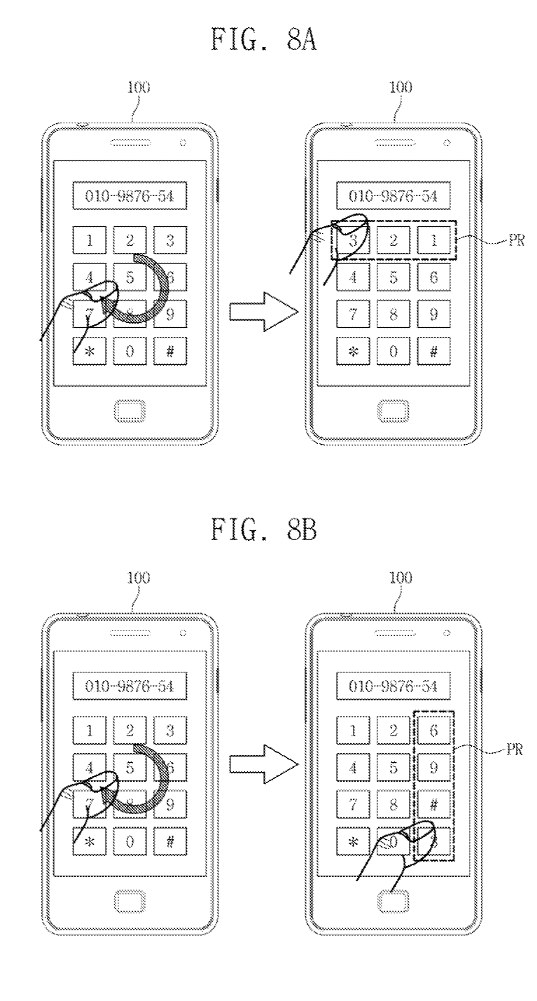

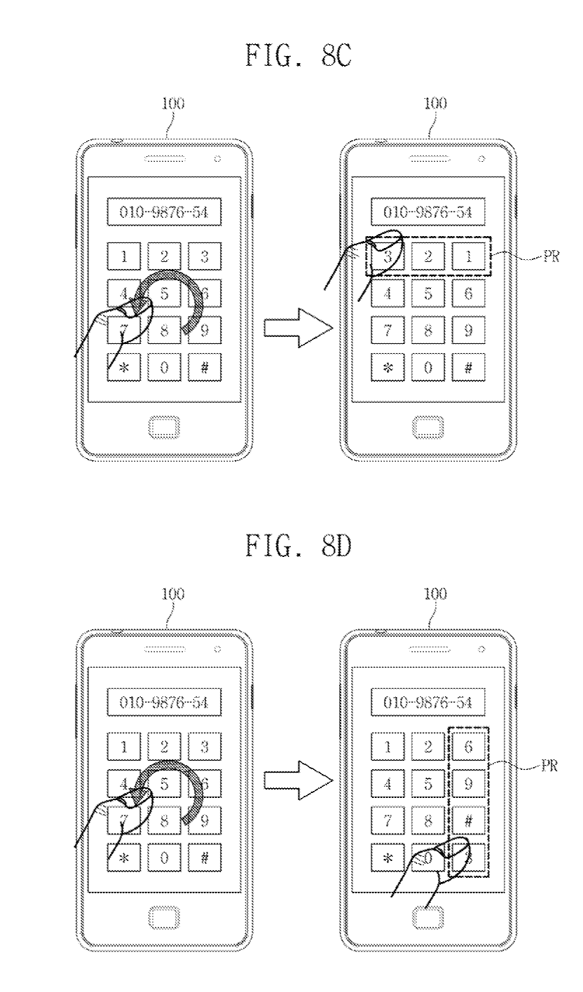

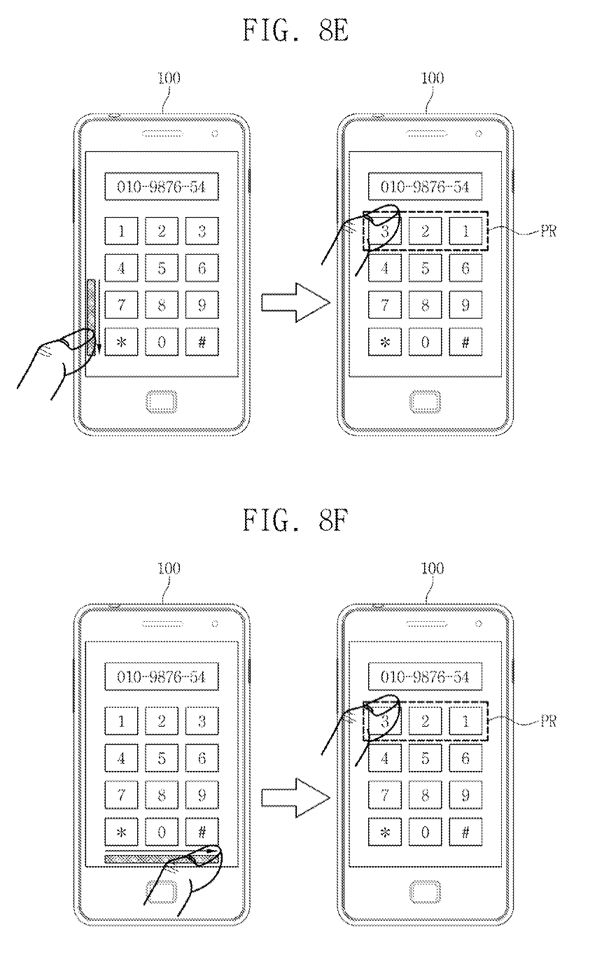

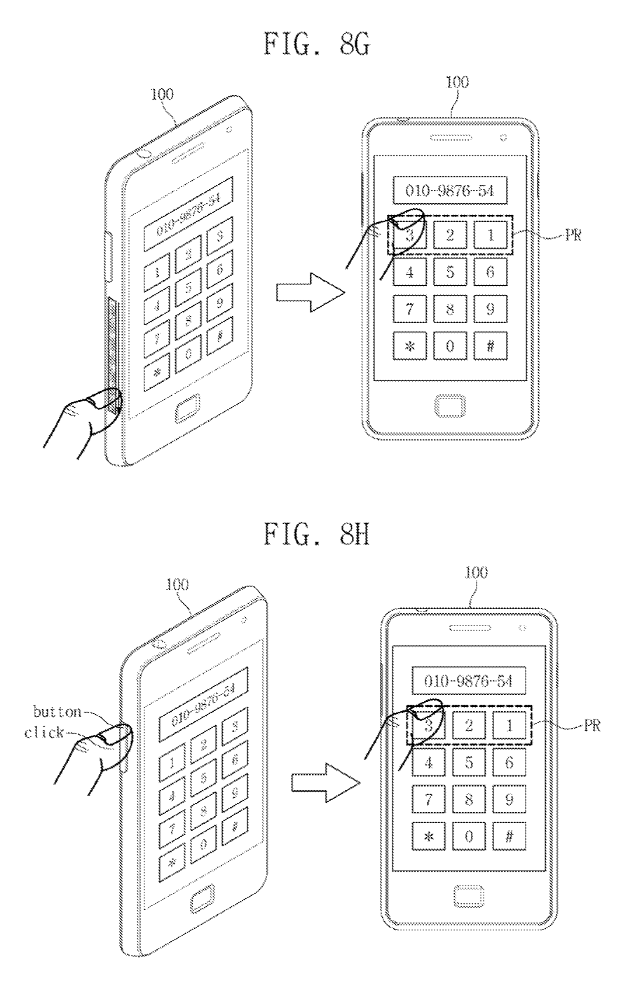

FIGS. 8A to 8H illustrate scrolling an image displayed on the display device of FIG. 1 using an image processor in accordance with exemplary embodiments of the inventive concept;

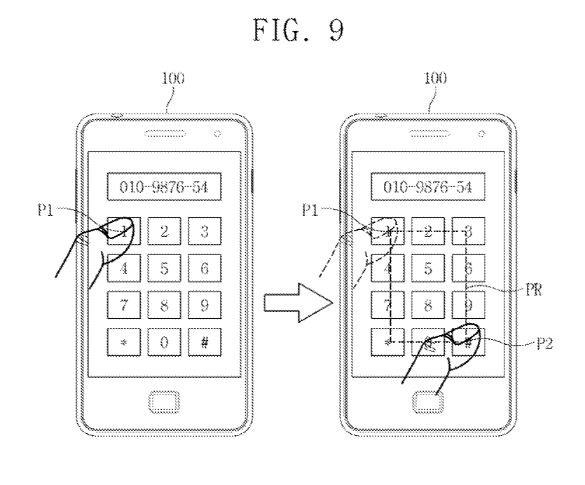

FIG. 9 illustrates setting a partial region of an image on the display device of FIG. 1 in accordance with an exemplary embodiment of the inventive concept;

FIGS. 10A and 10B illustrate setting a partial region of an image on the display device of FIG. 1 in accordance with exemplary embodiments of the inventive concept;

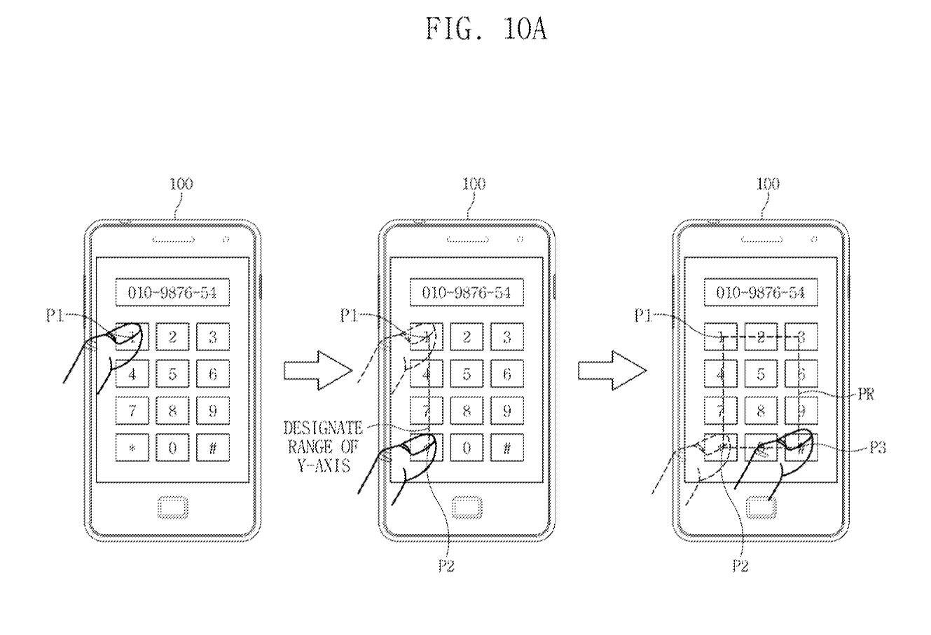

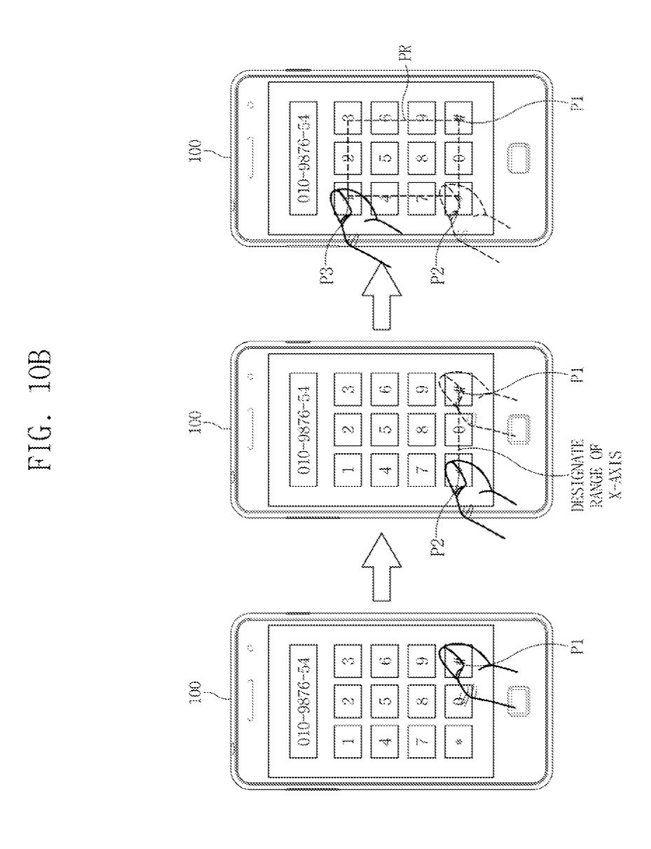

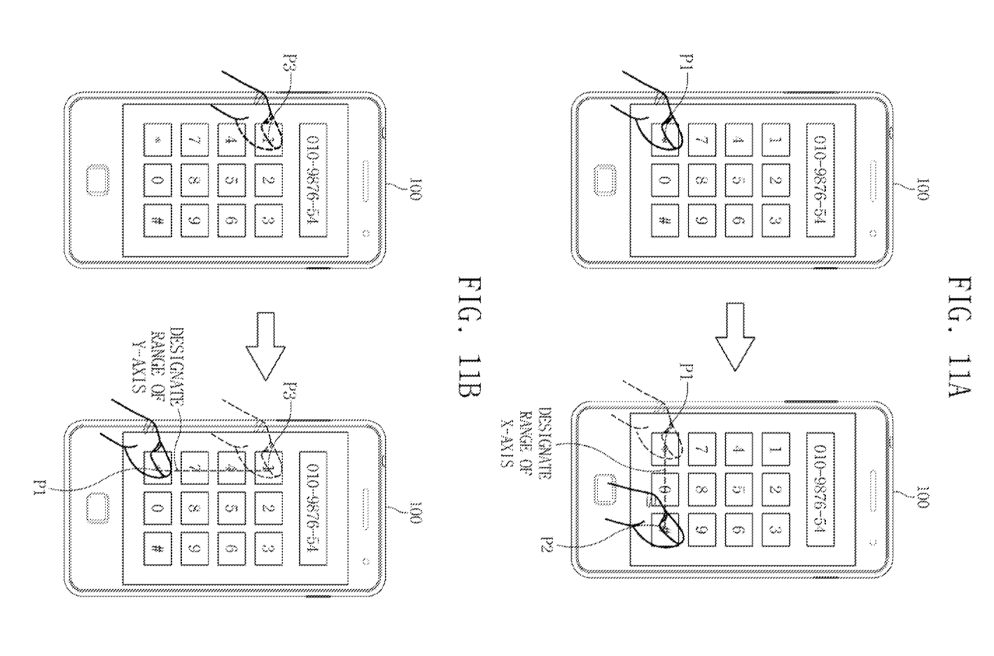

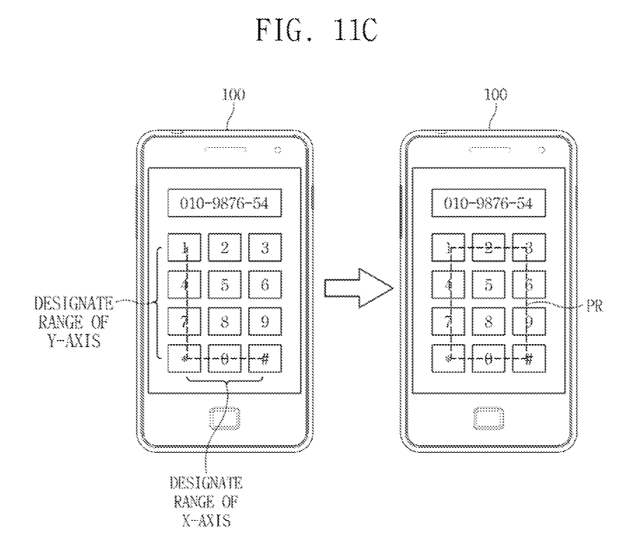

FIGS. 11A to 11C illustrate setting a partial region of an image on the display device of FIG. 1 in accordance with an exemplary embodiment of the inventive concept;

FIG. 12 illustrates setting a partial region of an image on the display device of FIG. 1 in accordance with an exemplary embodiment of the inventive concept;

FIG. 13 is a block diagram of a display device in accordance with an exemplary embodiment of the inventive concept;

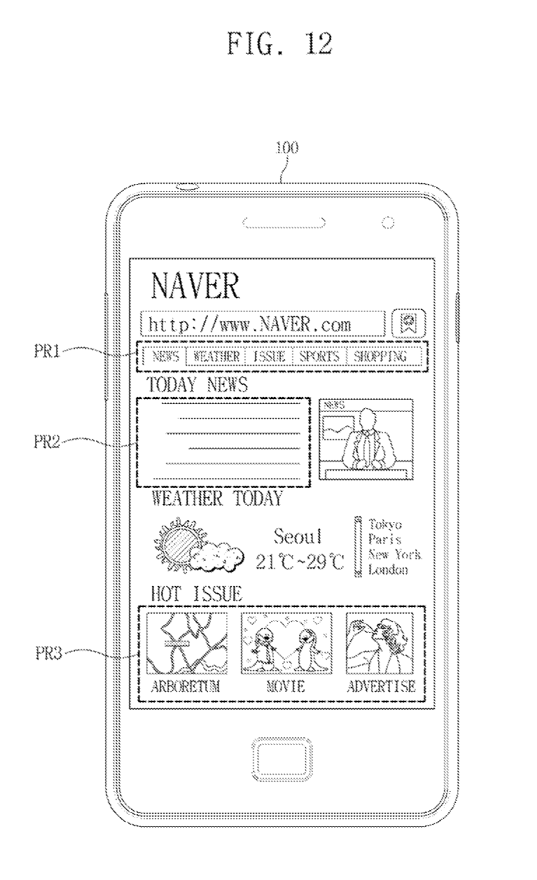

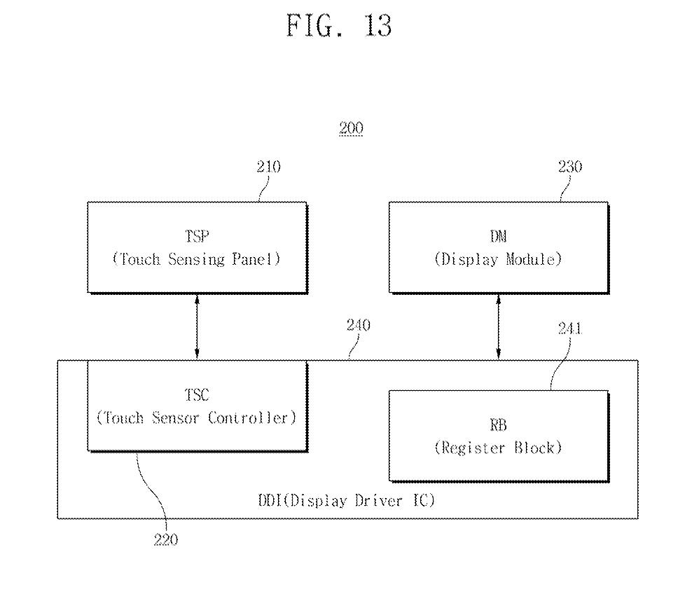

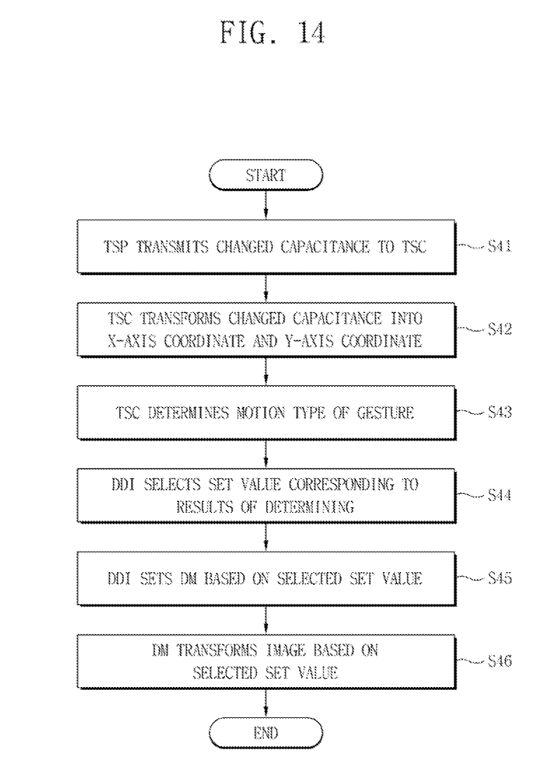

FIG. 14 is a flowchart illustrating a method of driving the display device of FIG. 13 in accordance with an exemplary embodiment of the inventive concept;

FIG. 15 is a block diagram of a computer system including the display device of FIG. 1 or 13 in accordance with an exemplary embodiment of the inventive concept;

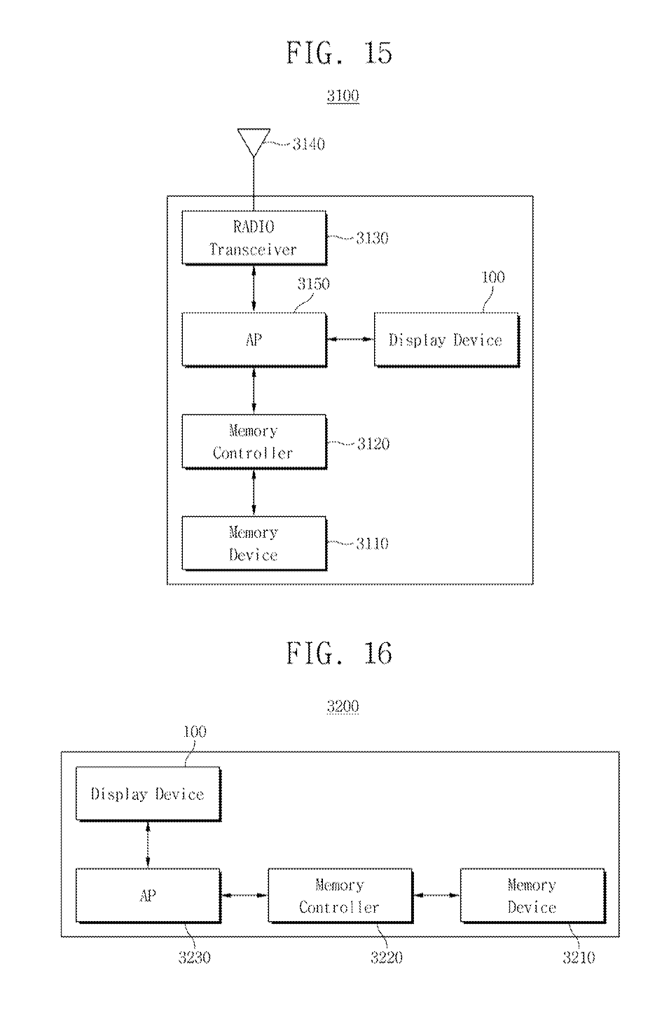

FIG. 16 is a block diagram of a computer system including the display device of FIG. 1 or 13 in accordance with an exemplary embodiment of the inventive concept; and

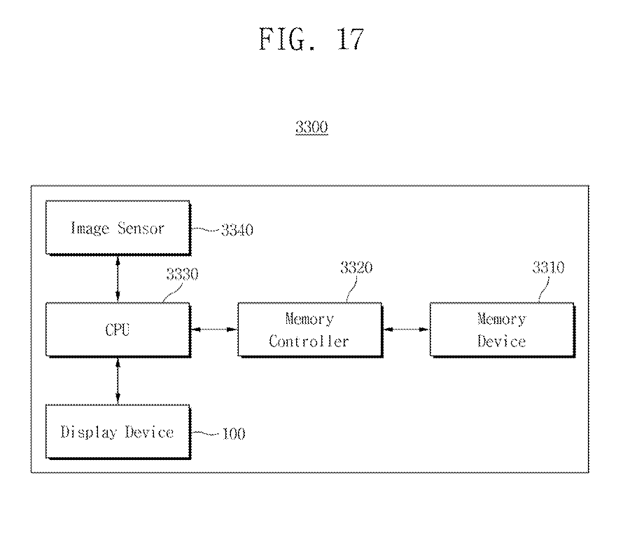

FIG. 17 is a block diagram of a computer system including the display device of FIG. 1 or 13 in accordance with an exemplary embodiment of the inventive concept.

### DETAILED DESCRIPTION OF THE EMBODIMENTS

Particular structural and functional descriptions regarding embodiments set forth herein are simply provided to explain these embodiments. Thus, the inventive concept may be accomplished in various embodiments and should not be construed as limited to the embodiments set forth herein.

The inventive concept may be embodied in different forms and particular embodiments of the inventive concept will thus be illustrated in the drawings and be described in the present disclosure in detail. However, the inventive concept is not limited to the particular embodiments and should be construed as covering all of modifications, equivalents, and substitutes thereof.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

It will be understood that when an element or layer is referred to as being “connected to” or “coupled to” another element or layer, it can be directly connected or coupled to the other element or layer or intervening elements or layers may be present.

Hereinafter, exemplary embodiments of the inventive concept will be described with reference to the accompanying drawings.

FIG. 1 is a block diagram of a display device 100 in accordance with an exemplary embodiment of the inventive concept.

Referring to FIG. 1, the display device 100 includes a touch-sensing panel 110, and a touch sensor controller 120 configured to control the touch-sensing panel 110. The display device 100 further includes a display module 130 configured to display an image thereon, and a display driver integrated circuit (IC) 140 configured to control the display module 130.

The touch sensor controller 120 and the display driver IC 140 may be connected directly via a first channel C1, or may be connected via a system bus 160.

A system bus 160 may connect the touch sensor controller 120, the display driver IC 140, and an image processor 150 to exchange data or control signals with one another. For example, the system bus 160 may be an inter-integrated circuit (I²C) bus used to establish communication between chips, a serial peripheral interface (SPI) bus, or the like.

The display device 100 further includes an image processor 150 configured to control the display driver IC 140 via the system bus 160, or to directly control the display driver IC 140 via a second channel C2. The image processor 150 may also control the touch sensor controller 120 via the system bus 160.

The image processor 150 may be embodied as one functional block of an application processor configured to drive the display device 100, or the application processor may act as the image processor 150. Otherwise, the image processor 150 may be embodied as an independent chip, similar to the application processor.

Examples of an application processor that may be generally used in smart phones may include Snapdragon™ manufactured by Qualcomm, Exynos™ manufactured by Samsung, Tegra2™ manufactured by NVidia, etc.

A user may input desired information to the touch-sensing panel 110 by using gestures. For example, keywords may be input, by a user, to provide telephone numbers or to search for information. Gestures in accordance with exemplary embodiments of the inventive concept will be described in detail with reference to FIGS. 3A to 4J below.

In the touch-sensing panel 110, metal electrodes are stacked and distributed. Thus, when a user touches or performs gestures on the touch-sensing panel 110, capacitance between the metal electrodes of the touch-sensing panel 110 changes. The touch-sensing panel 110 transmits the changed capacitance to the touch sensor controller 120. The touch-sensing panel 110 may employ not only a touch-sensing method using a change in the capacitance but also a resistive film touching method, an optical touching method, etc.

The touch sensor controller 120 determines a gesture based on the changed capacitance. For example, the touch sensor controller 120 determines whether a gesture is a clockwise motion or a counterclockwise motion.

The touch sensor controller 120 transmits the results of determining the gesture to the display driver IC 140 via the first channel C1 or the system bus 160.

The display driver IC 140 includes a register block 141 storing a set value for controlling the display module 130. The display driver IC 140 may transform an image displayed on the display module 130, based on the set value stored in the register block 141. For example, the register block 141 may store a set value for flipping or scrolling the image displayed on the display module 130 from top to bottom or from left to right. According to one exemplary embodiment of the present invention, flipping the displayed image from top to bottom need not create a rendering of an upside-down image, but rather, displayed elements from the top of the screen may be brought down towards the bottom of the screen while displayed elements from the bottom of the screen may be brought up towards the top of the screen. However, each element may retain its original orientation. This process may be described herein as “flipping” although it is to be understood that the image is not necessarily rendered upside-down.

The display driver IC 140 flips or scrolls the image displayed on the display module 130, based on the results of determining the gesture, which are received from the touch sensor controller 120. A method of flipping or scrolling an image displayed on the display module 130 will be described in detail with reference to FIGS. 5A to 6J below.

Otherwise, the touch sensor controller 120 transmits the results of determining the gesture to the image processor 150 via the system bus 160. The image processor 150 transmits the results of processing, e.g., flipping or scrolling, the image displayed on the display module 130 based on the results of determining the gesture, which are received from the touch sensor controller 120, to the display driver IC 140. The display driver IC 140 controls the results of processing the image to be output to the display module 130. A method of processing an image displayed on the display module 130 by using the image processor 150 will be described in detail with reference to FIGS. 7A to 8H below.

The display device 100 illustrated in FIG. 1 may be driven according to one of three driving methods. According to a first driving method, the touch sensor controller 120 determines a gesture and the display driver IC 140 transforms an image to correspond to a result of determining the gesture. The first driving method will be described in detail with reference to FIG. 2A below.

According to a second driving method, the touch sensor controller 120 determines a gesture and the image processor 150 transmits a command corresponding to the results of determining the gesture to the display driver IC 140 so as to transform an image according to the command. The second driving method will be described in detail with reference to FIG. 2B below.

According to a third driving method, the image processor 150 determines a gesture and transmits a command corresponding to the results of determining the gesture to the display driver IC 140 so as to transform an image according to the command. The third driving method will be described in detail with reference to FIG. 2C below.

FIGS. 2A to 2C are flowcharts illustrating methods of driving the display device 100 of FIG. 1 in accordance with embodiments of the inventive concept.

Referring to FIGS. 1 and 2A, in operation S11, when a user performs a gesture on the touch-sensing panel 110, the touch-sensing panel 110 transmits the capacitance between the metal electrodes of the touch-sensing panel 110, which changes to correspond to the gesture, to the touch sensor controller 120.

In operation S12, the touch sensor controller 120 transforms the changed capacitance into an X-axis coordinate and a Y-axis coordinate.

In operation S13, the touch sensor controller 120 determines a motion type of the gesture received from the touch-sensing panel 110, based on these coordinates. For example, the touch sensor controller 120 may determine whether the gesture is a clockwise motion or a counterclockwise motion.

In operation S14, the touch sensor controller 120 transmits the results of determining the gesture to the display driver IC 140 via the first channel C1 or the system bus 160. The touch sensor controller 120 also transmits the results of determining the gesture to the image processor 150 via the system bus 160.

In operation S15, the display driver IC 140 selects a register set value corresponding to the results of determining the gesture from among set values stored in the register block 141, and sets the display module 130 based on the selected register set value.

In operation S16, the display module 130 transforms an image, based on the selected register set value. The display driver IC 140 informs the image processor 150 of a change in the image via the second channel C2 or the system bus 160.

In operation S17, the image processor 150 informs the display driver IC 140 that the change of the image is normally received, via the second channel C2 or the system bus 160.

Referring to FIGS. 1 and 213, in operation S21, when a user performs a gesture on the touch-sensing panel 110, the touch-sensing panel 110 transmits a capacitance that changes to correspond to the gesture, to the touch sensor controller 120.

In operation S22, the touch sensor controller 120 transforms the changed capacitance into an X-axis coordinate and a Y-axis coordinate.

In operation S23, the touch sensor controller 120 determines a motion type of the gesture received from the touch-sensing panel 110, based on these coordinates. For example, the touch sensor controller 120 may determine whether the gesture is a clockwise motion or a counterclockwise motion.

In operation S24, the touch sensor controller 120 transmits the results of determining the gesture to the image processor 150 via the system bus 160.

In operation S25, the image processor 150 transmits a command corresponding to the results of determining the gesture to the display driver IC 140.

In operation S26, the display driver IC 140 controls the display module 130 to transform an image according to the command.

In operation S27, the display module 130 transforms the image, and the display driver IC 140 informs the image processor 150 of a change in the image via the second channel C2 or the system bus 160.

In operation S28, the image processor 150 informs the display driver IC 140 that the change in the image is normally received, via the second channel C2 or the system bus 160.

Referring to FIGS. 1 and 2C, in operation S31, when a user performs a gesture on the touch-sensing panel 110, the touch-sensing panel 110 transmits a capacitance that changes to correspond to the gesture to the touch sensor controller 120.

In operation S32, the touch sensor controller 120 transforms the changed capacitance into an X-axis coordinate and a Y-axis coordinate.

In operation S33, the touch sensor controller 120 transmits these coordinates to the image processor 150 via the system bus 160.

In operation S34, the image processor 150 determines a motion type of the gesture received from the touch-sensing panel 110, based on these coordinates. For example, the touch sensor controller 120 may determine whether the gesture is a clockwise motion or a counterclockwise motion. Also, the image processor 150 transmits a command corresponding to a result of determining the gesture to the display driver IC 140.

In operation S35, the display driver IC 140 controls the display module 130 to transform an image according to the command.

In operation S36, the display module 130 transforms the image. The display driver IC 140 informs the image processor 150 of a change in the image via the second channel C2 or the system bus 160.

In operation S37, the image processor 150 informs the display driver IC 140 that the change in the image is normally received, via the second channel C2 or the system bus 160.

FIGS. 3A to 3D illustrate gestures input to the touch-sensing panel 110 of FIG. 1 in accordance with embodiments of the inventive concept. FIGS. 3A to 3D illustrate cases in which a clockwise or counterclockwise motion (e.g., gesture) is input to the touch-sensing panel 110.

Referring to FIG. 3A, a user performs a clockwise gesture on the display device 100.

Referring to FIG. 3B, a user touches the display device 100, maintains the touching for one to two seconds, and performs the clockwise gesture so that this gesture in accordance with an embodiment of the inventive concept may be differentiated from a general clockwise motion.

Referring to FIG. 3C, a user performs a counterclockwise gesture on the display device 100.

Referring to FIG. 3D, a user touches the display device 100, maintains the touching for one to two seconds, and performs the counterclockwise gesture so that this gesture in accordance with an embodiment of the inventive concept may be differentiated from a general counterclockwise motion.

The gestures illustrated in FIGS. 3A to 3D are performed with the user's left thumb but may be performed with the user's right thumb. However, the gestures of FIGS. 3A to 3D in accordance with embodiments of the inventive concept are not limited to being performed with the user's right or left thumb as other fingers or a stylus device may be used.

FIGS. 4A to 4J illustrate gestures input to the touch-sensing panel 110 of FIG. 1 in accordance with exemplary embodiments of the inventive concept. FIGS. 4A to 4J illustrate cases in which a sliding gesture is performed on a left, right, or bottom side of the touch-sensing panel 110.

Referring to FIG. 4A, a user performs a sliding gesture of touching the right side of the display device 100 and sliding downward on the right side with his/her right thumb.

Referring to FIG. 4B, a user performs a sliding gesture of touching the right side of the display device 100 and sliding upward on the right side with his/her right thumb.

Referring to FIG. 4C, a user performs a sliding gesture of touching the left side of the display device 100 and sliding upward on the left side with his/her left thumb.

Referring to FIG. 4D, a user performs a sliding gesture of touching the left side of the display device 100 and sliding downward on the left side with his/her left thumb.

Referring to FIG. 4E, a user performs a sliding gesture of touching the bottom side of the display device 100 and sliding on the bottom side from left to right with his/her left thumb.

Referring to FIG. 4F, a user inputs a sliding gesture of touching the bottom side of the display device 100 and sliding on the bottom side from right to left with his/her right thumb.

The gestures of FIGS. 4A to 4F in accordance with embodiments of the inventive concept are not limited to performing sliding with the user's right or left thumb as other fingers and/or a stylus device may be used.

Referring to FIGS. 4G and 4H, a touch-sensing device (“pattern”) is attached to the left or right side of the display device 100 in accordance with an embodiment of the inventive concept so as to flip or scroll an image on the display device 100. The touch-sensing pattern may perform the same function as the touch-sensing panel 110 described above with respect to FIG. 1. The touch-sensing pattern need not be a touch screen display device and it may simply register touch without displaying images. Alternatively, the touch-sensing pattern may be a touch-sensitive display device.

Referring to FIG. 4G, a user performs a sliding gesture of touching the touch-sensing pattern on the left side of the display device 100 and sliding downward on the touch-sensing pattern with his/her left thumb. Also, although not shown, the user may perform a sliding gesture of touching the left side of the display device 100 and sliding upward on the left side with his/her left thumb.

Referring to FIG. 4H, a user performs a sliding gesture of a touch-sensing pattern on the right side of the display device 100 and sliding upward on the touch-sensing pattern with his/her right thumb. Also, although not shown, the user may perform a sliding gesture of touching the right side of display device 100 and sliding downward on the right side with his/her right thumb.

Referring to FIGS. 4I and 4J, a button is formed on the left or right side of the display device 100 in accordance with an embodiment of the inventive concept to flip or scroll an image displayed on the display device 100.

Referring to FIG. 4I, a user performs a gesture of clicking a button on the left side of the display device 100 with his/her left thumb.

Referring to FIG. 4J, a user performs a gesture of clicking a button on the right side of the display device 100 with his/her right thumb.

Also, although not shown, a button may further be formed on upper and lower portions of a side surface of the display device 100 to flip or scroll an image displayed on the display device 100.

A method of flipping an image displayed on the display device 100 according to a gesture input thereto will now be described in detail with reference to FIGS. 5A to 5J. Also, a method of scrolling an image displayed on the display device 100 according to a gesture input thereto will now be described in detail with reference to FIGS. 6A to 6J.

FIGS. 5A to 5J illustrate flipping an image displayed on the display device 100 of FIG. 1 in accordance with exemplary embodiments of the inventive concept.

Referring to FIGS. 1 and 5A, when a user performs a clockwise gesture on the display device 100, an image displayed on the display device 100 is flipped from left to right. The flipping may be an actual mirror image flipping, as shown, or alternatively the order of the objects rendered on screen may be reversed without reversing the display of each drawn object. Then, the user may more easily touch the number ‘3’ on the image that is flipped from left to right.

While it is to be understood that re-ordering the rendered objects may be managed at the operating system level of the smartphone, mirror image flipping may be more easily handled at the level of the display driver or that of the image processor. An image may be flipped from left to right using a set value stored in the register block 141 included in the display driver IC 140. The register block 141 stores a set value for flipping an image from left to right or from top to bottom. Also, the register block 141 may store a set value for scrolling the entire image or only a partial region of the image. The display driver IC 140 may transform an image based on the set value stored in the register block 141.

Otherwise, an image may be flipped from left to right using the image processor 150. The image processor 150 generates a command for transforming an image, and transmits the command to the display driver IC 140. The display driver IC 140 controls the display module 130 according to the command.

Referring to FIG. 5B, when a user performs a clockwise gesture on the display device 100, an image displayed on the display device 100 is flipped from top to bottom. Then, the user may more easily touch the number ‘3’ on the image that is flipped from top to bottom.

An image may be flipped from top to bottom using a register set value stored in the register block 141. Otherwise, an image may be flipped from top to bottom using the image processor 150.

Referring to FIG. 5C, when a user performs a counterclockwise gesture on the display device 100, an image displayed on the display device 100 is flipped from left to right. Then, the user may more easily touch the number ‘3’ on the image that is flipped from left to right.

Referring to FIG. 5D, when a user a counterclockwise gesture on the display device 100, an image displayed on the display device 100 is flipped from top to bottom. Then, the user may more easily touch the number ‘3’ on the image that is flipped from top to bottom.

FIGS. 5A to 5D illustrate gestures of inputting telephone numbers to the display device 100 of FIG. 1, whereas FIGS. 5E and 5F illustrate touching an image of the NAVER™ homepage on the display device 100 of FIG. 1.

Referring to FIG. 5E, when a user performs a clockwise gesture on the display device 100, an image displayed on the display device 100 is flipped from left to right. Then, the user may more easily touch a first article A1 on the image that is flipped from left to right.

Referring to FIG. 5F, when a user performs a clockwise gesture on the display device 100, an image displayed on the display device 100 is flipped from top to bottom. Then, the user may more easily touch a second article A2 on the image that is flipped from top to bottom.

Referring to FIG. 5G, when a user performs a sliding gesture of touching the right side of the display device 100 and sliding downward on the right side with his/her right thumb, an image displayed on the display device 100 is flipped from top to bottom. Then, the user may more easily touch the number ‘3’ on the image that is flipped from top to bottom.

Referring to FIG. 5H, when a user performs a sliding gesture of touching the bottom side of the display device 100 and sliding on the bottom side from left to right with his/her left thumb, an image displayed on the display device 100 is flipped from top to bottom. Then, the user may more easily touch the number ‘3’ on the image that is flipped from top to bottom.

Referring to FIG. 5I, when a user performs a sliding gesture of touching a touch-sensing pattern on the right side of the display device 100 and sliding upward on the touch-sensing pattern with his/her right thumb, an image displayed on the display device 100 is flipped from top to bottom. Then, the user may more easily touch the number ‘1’ on the image that is flipped from top to bottom.

Referring to FIG. 5J, when user clicks a button on the left side of the display device 100 with his/her left thumb, an image displayed on the display device 100 is flipped from top to bottom. Then, the user may more easily touch the number ‘3’ on the image that is flipped from top to bottom.

FIGS. 6A to 6J illustrate scrolling an image displayed on the display device 100 of FIG. 1 in accordance with embodiments of the inventive concept.

Referring to FIG. 6A, when a user performs a clockwise gesture on the display device 100, an entire image displayed on the display device 100 is scrolled downward.

In this case, a telephone number displaying region may be moved to a lower portion and the ‘*’ button, ‘0’ button, and ‘#’ button that are located on a lowermost portion, are moved to an uppermost portion. For example, all regions of the image are scrolled downward according to the clockwise gesture. Accordingly, the user may more easily touch the number ‘3’ on the scrolled image.

Referring to FIG. 6B, when a user performs a clockwise gesture on the display device 100, an entire image displayed on the display device 100 is scrolled upward. It is to be understood that scrolling, as herein defined, may include a wrap-around affect whereby image elements that are scrolled above the screen reappear below the screen while image elements that are scrolled off to the left of the screen reappear from the right and visa versa. As was the case with flipping, scrolling may be handled at the level of the display driver, the image processor, or at an operating system/application level.

In this case, the ‘1’ button, ‘2’ button, and ‘3’ button are moved to a lowermost portion. For example, all regions of the image are scrolled upward according to the clockwise gesture. Accordingly, the user may more easily touch the number ‘3’ on the scrolled image.

Referring to FIG. 6C, when a user performs a clockwise gesture on the display device 100, only a region, e.g., a partial region PR, of an image displayed on the display device 100 is scrolled. For example, the location of a telephone number displaying region may be maintained, and only a telephone number inputting portion is scrolled downward. Thus, the user may more easily touch the number ‘3’ on the scrolled image.

Referring to FIG. 6D, when a user performs a clockwise gesture on the display device 100, only a partial region PR of the display device 100 is scrolled. For example, location of a telephone number displaying region is maintained, and only a telephone number inputting portion is scrolled to the right. Thus, the user may more easily touch the number ‘3’ on the scrolled image.

FIGS. 6A to 6D illustrate inputting telephone numbers to the display device 100 of FIG. 1, where FIG. 6E illustrates touching a shopping button SB on an image of the NAVER™ homepage displayed on the display device 100 of FIG. 1, and FIG. 6F illustrates touching a NAVER™ homepage button HB of the image displayed on the display device 100 of FIG. 1.

Referring to FIG. 6E, a user may have difficulties touching the shopping button SB located on an upper right portion of the image with his/her left thumb. To solve this problem, the user may perform a clockwise motion on the display device 100. Then, the entire image on the display device 100 is scrolled to the right. Thus, the user may more easily touch the shopping button SB.

Referring to FIG. 6F, a user may have difficulties touching the home button HB on an upper left portion of the image with his/her left thumb. To solve this problem, the user may perform a clockwise motion on the display device 100. Then, the entire image on the display device 100 is scrolled downward. Accordingly, the user may more easily touch the NAVER™ homepage button HB.

Referring to FIG. 6G, when a user performs a sliding gesture of touching the right side of the display device 100 and sliding downward on the right side with his/her right thumb, the entire image displayed on the display device 100 is scrolled downward. For example, a telephone number displaying region may be moved to a lower portion, and the “*” button, ‘0’ button, and ‘#’ button that are located on a lowermost portion, are moved to an uppermost portion. Accordingly, the user may more easily touch the number ‘1’ on the scrolled image.

Referring to FIG. 6H, when a user performs a sliding gesture of touching the bottom side of the display device 100 and sliding on the bottom side from left to right with his/her left thumb, the entire image displayed on the display device 100 is scrolled downward. For example, a telephone number displaying region may be moved to a lower portion, and the “*” button, ‘0’ button, and ‘#’ button that are located on a lowermost portion, are moved to an uppermost portion. Accordingly, the user may more easily touch the number ‘3’ on the scrolled image.

Referring to FIG. 6I, when a user performs a sliding gesture of touching a touch-sensing pattern on the left side of the display device 100 and sliding upward on the touch-sensing pattern with his/her right thumb, the entire image displayed on the display device 100 is scrolled downward. For example, a telephone number displaying region may be moved to a lower portion, and the ‘*’ button, ‘0’ button, and IP button that are located on a lowermost portion, are moved to an uppermost portion. Accordingly, the user may more easily touch the number ‘1’ on the scrolled image.

Referring to FIG. 6J, when a user clicks a button on the left side of the display device 100 with his/her left thumb, the entire image displayed on the display device 100 is scrolled downward. For example, a telephone number displaying region may be moved to a lower portion, and the ‘*’ button, ‘0’ button, and ‘#’ button that are located on a lowermost portion, are moved to an uppermost portion. Accordingly, the user may more easily touch the number ‘3’ on the scrolled image.

FIGS. 5A to 6J illustrate embodiments in which an image may be flipped or scrolled without performing image processing with the image processor 150. Also, according to the approaches shown in FIGS. 5A to 6J, an image may be flipped or scrolled based on a command given from the image processor 150.

FIGS. 7A to 7H and 8A to 8H illustrate flipping or scrolling an image based on a command given from the image processor 150 in accordance with embodiments of the inventive concept.

FIGS. 7A to 7H illustrate flipping an image displayed on the display device 100 of FIG. 1 by using the image processor 150 in accordance with embodiments of the inventive concept.

Referring to FIG. 7A, a user performs a clockwise gesture on the display device 100. In this case, an image displayed on the display device 100 is not flipped from left to right but only the order of number buttons in the image is flipped from left to right. Thus, the user may more easily touch the number ‘3’ on the image in which the number buttons are flipped.

Only the number buttons in the image may be flipped from left to right using the image processor 150. The image processor 150 generates a command for transforming an image, and transmits the command to the display driver IC 140. The display driver IC 140 controls the display module 130 in response to the command.

Referring to FIG. 7B, a user performs a clockwise gesture on the display device 100. In this case, an image displayed on the display device 100 is not flipped from top to bottom but only the order of number buttons in the image is flipped from top to bottom. Thus, the user may more easily touch the number ‘3’ on the image in which the number buttons are flipped.

Only the number buttons in the image may be flipped from top to bottom by using the image processor 150.

Referring to FIG. 7C, a user performs a counterclockwise gesture on the display device 100. In this case, an image displayed on the display device 100 is not flipped from top to bottom but only the order of number buttons in the image is flipped from top to bottom. Thus, the user may more easily touch the number ‘3’ on the image in which the number buttons are flipped.

Referring to FIG. 7D, a user performs a counterclockwise gesture on the display device 100. In this case, an image displayed on the display device 100 is not flipped from left to right but only the order of number buttons in the image is flipped from left to right. Thus, the user may more easily touch the number ‘3’ on the image in which the number buttons are flipped.

Referring to FIG. 7E, a user performs a sliding gesture of touching the left side of the display device 100 and sliding downward on the left side with his/her left thumb.

In this case, an image displayed on the display device 100 is not flipped from left to right but only the order of number buttons is flipped from left to right. Thus, the user may more easily touch the number ‘3’ on the image in which the number buttons are flipped.

Also, the user may flip the image on the display device 100 from left to right by inputting a sliding gesture of touching the left side of the display device 100 and sliding upward on the left side.

Referring to FIG. 7F, a user performs a sliding gesture of touching the bottom side of the display device 100 and sliding on the bottom side from left to right with his/her left thumb.

In this case, an image displayed on the display device 100 is not flipped from left to right but only the order of number buttons in the image is flipped from left to right. Thus, the user may more easily touch the number ‘3’ on the image in which the number buttons are flipped.

Also, the user may flip the image on the display device 100 from left to right by inputting a sliding gesture of touching the bottom side of the display device 100 and sliding on the bottom side form right to left.

Referring to FIG. 7G, a user performs a sliding gesture of touching a touch-sensing pattern on the left side of the display device 100 and sliding upward on the touch-sensing pattern with his/her left thumb.

In this case, the image on the display device 100 is not flipped from left to right but only the order of number buttons in the image is flipped from left to right. Thus, the user may more easily touch the number ‘3’ on the image in which the number buttons are flipped.

Also, the user may flip the image on the display device 100 from left to right by inputting a sliding gesture of touching a touch-sensing pattern on the left side of the display device 100 and sliding upward on the touch-sensing pattern.

Referring to FIG. 7H, a user clicks a button on the left side of the display device 100 with his/her left thumb.

In this case, the image on the display device 100 is not flipped from left to right but only the order of number buttons in the image is flipped from left to right. Thus, the user may more easily touch the number ‘3’ on the image in which the number buttons are flipped.

FIGS. 8A to 8H illustrate scrolling an image displayed on the display device 100 of FIG. 1 by using the image processor 150 in accordance with various exemplary embodiments of the inventive concept.

Referring to FIG. 8A, a user performs a clockwise gesture on the display device 100 with his/her left thumb.

In this case, only number buttons displayed in a region, e.g., a partial region PR, of an image displayed on the display device 100 are scrolled in the left and right directions. Thus, the user may more easily touch the number ‘3’ from among the numbers that are symmetrical in the partial region PR in the left and right directions.

Referring to FIG. 8B, a user performs a clockwise gesture on the display device 100 with his/her left thumb.

Then, only number buttons displayed in a partial region PR of an image displayed on the display device 100 are scrolled upward. Thus, the user may more easily touch the number ‘3’ from among the numbers in the partial region PR that are scrolled upward.

Referring to FIG. 8C, a user performs a counterclockwise gesture on the display device 100 with his/her left thumb.

Then, only number buttons displayed in a partial region PR of an image displayed on the display device 100 are scrolled in the left and right directions. Thus, the user may more easily touch the number ‘3’ from among the numbers that are symmetrical in the partial region PR in the left and right directions.

Referring to FIG. 8D, a user performs a counterclockwise gesture on the display device 100 with his/her left thumb.

Then, only number buttons displayed in a partial region PR of an image displayed on the display device 100 are scrolled upward. Thus, the user may more easily touch the number ‘3’ from among the numbers in the partial region PR that are scrolled upward.

Referring to FIG. 8E, a user performs a sliding gesture of touching the left side of the display device 100 and sliding downward on the left side with his/her left thumb.

Also, the user may scroll only the number buttons in the partial region PR in the left and right directions by inputting a sliding gesture of touching the left side of the display device 100 and sliding upward on the left side.

Referring to FIG. 8F, a user performs a sliding gesture of touching the bottom side of the display device 100 and sliding on the bottom side from left to right with his/her left thumb.

Then, only number buttons displayed in a partial region PR of an image displayed on the display device 100 are scrolled in the left and right directions. Thus, the user may more easily touch the number ‘3’ from among the numbers that are symmetrical in the partial region PR in the left and right directions.

Also, the user may scroll only the number buttons in the partial region PR in the left and right directions by inputting a sliding gesture of touching the bottom side of the display device 100 and sliding the bottom side from right to left.

Referring to FIG. 8G, a user performs a sliding gesture of touching a touch-sensing pattern on the left side of the display device 100 and sliding upward on the touch-sensing pattern with his/her left thumb.

Also, the user may scroll only the number buttons in the partial region PR in the left and right directions by inputting a sliding gesture of touching the touch-sensing pattern on the left side of the display device 100 and sliding upward on the touch-sensing pattern.

Referring to FIG. 8H, a user clicks a button on the left side of the display device 100 with his/her left thumb.

Then, only number buttons displayed in a partial region PR of an image displayed on the display device 100 are scrolled in the left and right directions. Thus, the user may more easily touch the number ‘3’ from among the numbers that are symmetrical in the partial region PR in the left and right directions.

The partial region PR may be determined right before such a gesture is input to the display device 100, or may be determined beforehand. A method of determining the partial region PR will be described in detail with reference to FIGS. 9 and 11C below.

FIG. 9 illustrates setting a partial region of an image on the display device 100 of FIG. 1 in accordance with an embodiment of the inventive concept.

Referring to FIG. 9, a user touches a first point P1 on the image with his/her left thumb. Then, the user touches a second point P2 on the image, which is perpendicular to the first point P1. For example, the user touches the second point P2 with an X-axis (horizontal axis) coordinate and a Y-axis (vertical axis) coordinate that are different from those of the first point P1.

Otherwise, the user may drag the second point P2 with an X-axis (horizontal axis) coordinate and a Y-axis (vertical axis) coordinate that are different from those of the first point P1, while touching the first point P1 with his/her left thumb.

A partial region PR may be set with the X-axis coordinates and the Y-axis coordinates of the first and second points P1 and P2. For example, the range of an X-axis of the partial region PR may be from the X-axis coordinate of the first point P1 to the X-axis coordinate of the second point P2, and the range of a Y-axis of the partial region PR may be from the Y-axis coordinate of the first point P1 to the Y-axis coordinate of the second point P2. Thus, the user may be defining a partial region PR box by tracing just a left side and bottom side, with the top side and right side being automatically determined therefrom.

The partial region PR may be set using the display driver IC 140.

Referring to FIG. 1, when the user touches first and second points P1 and P2 on the touch-sensing panel 110, the touch-sensing panel 110 senses the first and second points P1 and P2. The touch-sensing panel 110 transmits the results of sensing the first and second points P1 and P2, e.g., a change in a capacitance, to the touch sensor controller 120.

The touch sensor controller 120 transforms the change in capacitance into an X-axis coordinate and a Y-axis coordinate. The touch sensor controller 120 transmits the X-axis coordinate and the Y-axis coordinate to the display driver IC 140. The display driver IC 140 sets a partial region PR using the X-axis coordinate and the Y-axis coordinate.

Otherwise, the partial region PR may be set using the image processor 150.

When a user touches first and second points P1 and P2 on the touch-sensing panel 110, the touch-sensing panel 110 senses the first and second points P1 and P2. Then, the touch-sensing panel 110 transmits the results of sensing the first and second points P1 and P2, e.g., a change in a capacitance, to the touch sensor controller 120.

The touch sensor controller 120 transforms the change in capacitance into an X-axis coordinate and a Y-axis coordinate. The touch sensor controller 120 transmits the X-axis coordinate and the Y-axis coordinate to the image processor 150 via the system bus 160. The image processor 150 sets a partial region PR based on the X-axis coordinate and the Y-axis coordinate.

FIGS. 10A and 10B illustrate setting a partial region of an image on the display device 100 of FIG. 1 in accordance with exemplary embodiments of the inventive concept.

Referring to FIG. 10A, a user touches a first point P1 with his/her left thumb. Then, the user touches a second point P2 with an X-axis coordinate that is the same as that of the first point P1. By using the second point P2, a range of a Y-axis of the partial region PR is designated.

Then, the user touches a third point P3 with a Y-axis coordinate that is the same as that of the second point P2. By using the third point P3, a range of an X-axis of the partial region PR is designated.

Thus, the range of the X-axis of the partial region PR may be from the X-axis coordinate of the second point P2 to the X-axis coordinate of the third point P3. Also, the range of the Y-axis of the partial region PR may be from the Y-axis coordinate of the second point P2 to the Y-axis coordinate of the first point P1.

Referring to FIG. 10B, a user touches a first point P1 with his/her left thumb. Then, the user touches a second point P2 with a Y-axis coordinate that is the same as that of the first point P1. By using the second point P2, a range of an X-axis of a partial region PR is designated.

Then, the user touches a third point P3 with an X-axis coordinate that is the same as that of the second point P2. By using the third point P3, a range of an X-axis of the partial region PR is designated.

Thus, the range of the X-axis of the partial region PR may be from the X-axis coordinate of the second point P2 to the X-axis coordinate of the first point P1. Also, the range of the Y-axis of the partial region PR may be from the Y-axis coordinate of the second point P2 to the Y-axis coordinate of the third point P3.

FIGS. 11A to 11C illustrate setting a partial region on the display device 100 of FIG. 1 in accordance with an embodiment of the inventive concept.

FIG. 11A illustrates a method of designating a range of an X-axis of a partial region PR. FIG. 11B illustrates a method of designating a range of a Y-axis of the partial region PR. FIG. 11C illustrates a method of setting a partial region PR based on the range of the X-axis designated in FIG. 11A and the range of the Y-axis designated in FIG. 11B.

Referring to FIG. 11A, a user touches a first point P1 with his/her left thumb. Then, the user touches a second point P2 with a Y-axis coordinate that is the same as that of the first point P1. By using the second point P2, the range of the X-axis of the partial region PR is designated.

Referring to FIG. 11B, a user touches a third point P3 with his/her left thumb. Then, the user touches a first point P1 with an X-axis coordinate that is the same as that of the third point P3. By using the second point P1, the range of the Y-axis of the partial region PR is designated.

Referring to FIGS. 11A to 11C, the partial region PR may be set using the range of the X-axis designated in FIG. 11A and the range of the Y-axis designated in FIG. 11B.

FIG. 12 illustrates setting a partial region on the display device 100 of FIG. 1 in accordance with an exemplary embodiment of the inventive concept.

Referring to FIG. 12, an image of the NAVER™ homepage is displayed on the display device 100. The contents of the NAVER™ homepage may include a ‘main menu’ PR1, ‘today's news’ PR2, and ‘hot issues’ PR3. Each of the ‘main menu’ PR1, ‘today's news’ PR2, and ‘hot issues’ PR3 may be set beforehand to be scrolled in the left/right direction or the up/down direction according to a form in which it is spread.

For example, the ‘main menu’ PR1 may be set beforehand to be scrolled in the left/right direction. Also, the ‘today's news’ PR2 may be set beforehand to be scrolled in the up/down direction. The ‘hot issues PR3’ may be set beforehand to be scrolled in the left/right direction.

In addition to, or as an alternative to scrolling, flipping or sliding, exemplary embodiments of the present invention may use one or more of the aforementioned gesturing commands to reduce a size of the displayed image or an area within a partial region (PR) so that the displayed image may go from a full image to a size-reduced image located within a desired corner of the display so that an entirety of the displayed image is confined to an area that may be more easily reached by a user's finger while the device is held in one hand.

FIG. 13 is a block diagram of a display device 200 in accordance with an embodiment of the inventive concept.

Referring to FIG. 13, the display device 200 includes a touch-sensing panel 210 via which a gesture is input, a display module 230 configured to display an image thereon, and a display driver IC 240 configured to control the touch-sensing panel 210 and the display module 230.

The display driver IC 240 includes a touch sensor controller 220 configured to control the touch-sensing panel 210, and a register block 241 that stores a set value for controlling the display module 230.

In the touch-sensing panel 210, metal electrodes are stacked and distributed. Thus, when a user touches or performs a gesture on the touch-sensing panel 210, capacitance between the metal electrodes of the touch-sensing panel 210 changes. The touch-sensing panel 210 transmits the changed capacitance to the touch sensor controller 220.

The touch sensor controller 220 determines a gesture based on the changed capacitance. The display driver IC 240 selects a set value for flipping or scrolling an image from among set values stored in the register block 241, based on the results of determining the gesture, which are received from the touch sensor controller 220. The display module 230 flips or scrolls an image based on the selected set value. A method of driving the display device 200 illustrated in FIG. 13 will now be described in detail with reference to a flowchart of FIG. 14.

FIG. 14 is a flowchart illustrating a method of driving the display device 200 of FIG. 13 in accordance with an exemplary embodiment of the inventive concept.

Referring to FIG. 14, in operation S41, when a user performs a gesture on the touch-sensing panel 210, the touch-sensing panel 210 transmits a capacitance that changes according to the gesture, to the touch sensor controller 220.

In operation S42, the touch sensor controller 220 transforms the changed capacitance into an X-axis coordinate and a Y-axis coordinate.

In operation S43, the touch sensor controller 220 determines a motion type of the gesture performed on the touch-sensing panel 210, based on the X-axis coordinate and the Y-axis coordinate. For example, the touch sensor controller 220 determines whether the gesture is a clockwise motion or a counterclockwise motion.

In operation S44, the display driver IC 240 selects a set value for flipping or scrolling an image from among set values stored in the register block 241, based on the results of the determining performed by the touch sensor controller 220.

In operation S45, the display driver IC 240 sets the display module 230 based on the selected set value.

In operation S46, the display module 230 transforms an image based on the selected set value.

FIG. 15 is a block diagram of a computer system 3100 including the display device 100 of FIG. 1 or the display device 200 of FIG. 13 in accordance with an exemplary embodiment of the inventive concept.

Referring to FIG. 15, the computer system 3100 may be embodied as a smart phone, tablet computer, or a personal digital assistant (PDA).

The computer system 3100 includes a memory device 3110, a memory controller 3120 configured to control the memory device 3110, a wireless transceiver 3130, an antenna 3140, an application processor 3150, and a display device 100.

The wireless transceiver 3130 may transmit or receive a radio-frequency (RF) signal via the antenna 3140. For example, the wireless transceiver 3130 may transform an RF signal received via the antenna 3140 into a signal that may be processed by the application processor 3150.

Thus, the application processor 3150 may process a signal received from the wireless transceiver 3130, and transmit the processed signal to the display device 100. Also, the wireless transceiver 3130 may transform a signal received from the application processor 3150 into an RF signal, and transmit the RF signal to an external device via the antenna 3140.

In accordance with an embodiment of the inventive concept, the memory controller 3120 configured to control the memory device 3110 may be embodied as a part of the application processor 3150, or may be embodied as a chip formed separately from the application processor 3150.

The computer system 3100 may be embodied using the display device 200 of FIG. 13, instead of the display device 100 of FIG. 1.

FIG. 16 is a block diagram of a computer system 3200 including the display device 100 of FIG. 1 or the display device 200 of FIG. 13 in accordance with an exemplary embodiment of the inventive concept.

Referring to FIG. 16, the computer system 3200 may be embodied as a tablet computer, a personal computer (PC), a smart television, a video game console, a network server, a net-book, an e-reader, a PDA, a portable multimedia player (PMP), an MP3 player, or an MP4 player.

The computer system 3200 includes a memory device 3210, a memory controller 3220 configured to control a data processing operation of the memory device 3210, an application processor 3230, and a display device 100.

The application processor 3230 may display data stored in the memory device 3210 on the display device 100, based on data received via the display device 100.

The application processor 3230 may control overall operations of the computer system 3200, and control an operation of the memory controller 3220.

In accordance with an embodiment of the inventive concept, the memory controller 3220 configured to control the memory device 3210 may be embodied as a part of the application processor 3230, or may be embodied as a chip formed separately from the application processor 3230.

The computer system 3200 may be embodied using the display device 200 of FIG. 13, instead of the display device 100 of FIG. 1.

FIG. 17 is a block diagram of a computer system 3300 including the display device 100 of FIG. 1 or the display device 200 of FIG. 13 in accordance with an exemplary embodiment of the inventive concept.

Referring to FIG. 17, the computer system 3300 may be embodied as an image process device, e.g., a digital camera, a camcorder, or a mobile phone, a smart phone, or a tablet computer to which a digital camera is attached.

The computer system 3300 includes a memory device 3310, and a memory controller 3320 configured to control a data processing operation (e.g., a write operation or a read operation) of the memory device 3310. The computer system 3300 may further include a central processing unit (CPU) 3330, an image sensor 3340, and a display device 100.

The image sensor 3340 of the sensor computer system 3300 transmits an optical image into digital signals, and transmits the digital signals to the CPU 3330 or the memory controller 3320. The digital signals may be displayed on the display device 100, or may be stored in the memory device 3310 via the memory controller 3320, under control of the CPU 3330.

Data stored in the memory device 3310 is displayed on the display device 100, under control of the CPU 3330 or the memory controller 3320.

In accordance with an embodiment of the inventive concept, the memory controller 3320 configured to control an operation of the memory device 3310 may be embodied as a part of the CPU 3330, or may be embodied as a chip formed separately from the CPU 3330.

The computer system 3300 may be embodied using the display device 200 of FIG. 13, instead of the display device 100 of FIG. 1.

Display devices in accordance with embodiments of the inventive concept each include a touch sensor controller configured to determine a gesture, and a display driver IC configured to flip or scroll an image based on the results of performing the gesture, which are received from the touch sensor controller. Accordingly, a user can easily manipulate a large-screen display device with just one hand.

The foregoing is illustrative of embodiments and is not to be construed as limiting thereof. Although exemplary embodiments have been described, those skilled in the art will readily appreciate that many modifications are possible in embodiments without materially departing from the novel teachings and aspects of the present inventive concept. Accordingly, all such modifications are intended to be included within the scope of this inventive concept.

What is claimed is:

1. A display device which displays an image, comprising:
a touch sensor controller configured to identify a gesture made by a user on the display device and send an indication of the identification of the gesture; and
a display driver integrated circuit (IC) configured to receive the indication of the identification of the gesture from the touch sensor controller and adapt an image displayed on the display device in response to the receipt of the indication of the identification of the gesture,
wherein the image adaptation brings one or more touch targets displayed on the display device closer to a corner of the display device that is more easily accessible to the user.

2. The display device of claim 1, wherein the gesture comprises a clockwise motion or a counterclockwise motion.

3. The display device of claim 1, wherein the image adaptation includes flipping the image performed to invert the image to be flipped from top to bottom or from left to right.

4. The display device of claim 1, wherein the image adaptation includes scrolling the image shifting all regions or a partial region of the image from top to bottom or from left to right.

5. The display device of claim 1, wherein the image adaptation includes scaling down a resolution of the image and confining the image to a corner of an area that the image previously occupied on the display device.

6. The display device of claim 1, further comprising an image processor configured to control the display driver IC.

7. The display device of claim 6, wherein the image processor comprises the touch sensor controller.

8. The display device of claim 6, wherein the image processor is embodied as a functional block of an application processor,
wherein the application processor comprises the touch sensor controller.

9. The display device of claim 1, wherein the touch sensor controller is embodied as a functional block of the display driver IC.

10. The display device of claim 1, wherein the display driver IC comprises a set value for adapting the image.

11. A method of driving a display device that displays an image, comprising:
identifying a gesture made by a user on the display device; and
adapting the image when the gesture is identified,
wherein the adapting of the image brings one or more touch targets of the image closer to a corner of the display device that is more easily accessible to the user.

12. The method of claim 11, further comprising setting a partial region of the image.

13. The method of claim 12, wherein the setting of the partial region comprises:
touching a first point on the image; and
touching a second point with an X-axis coordinate and a Y-axis coordinate that are not the same as those of the first point,
wherein a range of an X-axis of the partial region is set using the X-axis coordinates of the first and second points, and a range of a Y-axis of the partial region is set using the Y-axis coordinates of the first and second points.

14. The method of claim 12, wherein the setting of the partial region comprises:
touching a first point on the image;
touching a second point with a Y-axis coordinate that is the same as that of the first point to set a range of an X-axis of the partial region; and
touching a third point with an X-axis coordinate that is the same as that of the second point to set a range of a Y-axis of the partial region.

15. The method of claim 12, wherein adapting the image includes flipping the image inverting all regions or the partial region of the image from top to bottom or from left to right.

16. The method of claim 12, wherein adapting the image includes scrolling the image shifting all regions or the partial region of the image from top to bottom or from left to right.

17. The method of claim 12, wherein the adapting of the image includes shrinking the image scaling down a resolution of the image and confining the image to a corner of an area that the image previously occupied on the display device.

18. A computer device, comprising:
a touch screen configured to display an image and sense user contact with the touch screen;
a processing device configured to interpret the sensed user contact, identify a gesture made by a user therefrom, and generate an identification signal when the gesture is identified; and
a display driver integrated circuit (IC) configured to receive the identification signal and alter a display of the image in response to the received identification signal,
wherein the altering of the display of the image brings one or more touch targets displayed on the display device closer to a corner of the display device that is more easily accessible to the user.

19. The computer device of claim 18, wherein the altering of the display of the image is performed entirely within the display driver integrated circuit (IC).

20. The computer device of claim 18, wherein the altering of the display of the image includes flipping, scrolling or shrinking the image.
